(19) United States
(12) Patent Application Publication
(10) Pub. No.: US 2004/0181612 A1
(43) Pub. Date: Sep. 16, 2004

(54) Method and system for controlling data transfer

(75) Inventor: Kenichi Kawaguchi, Hyogo (JP)

Correspondence Address: Jack Q. Lever, Jr., McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 10/775,124

(22) Filed: Feb. 11, 2004

(30) Foreign Application Priority Data
Mar. 12, 2003 (JP) 2003-067193

(51) Int. Cl. G06F 15/16

(52) U.S. Cl. 709/253

(57) ABSTRACT

When a burst data transfer is started and a data phase reaches an address to which data is not to be transferred, a byte enable signal is deasserted. When the data phase reaches an address to which data is to be transferred, the byte enable signal is asserted, and data to be transferred is updated only at the time when this data phase is completed. With such an arrangement, the data can be transferred only to destination addresses which are separated with intervals of several words.

### BACKGROUND OF THE INVENTION

1. Field of the Invention

The present invention relates to a method and system for controlling data transfer.

2. Description of the Prior Art

In a conventional data transfer control method and system for controlling a burst transfer, for example, as disclosed in Japanese Unexamined Patent Publication No. 6-161944, a transfer destination start address and the number of words to be transferred are set in a transfer destination start address register and a transferred-word number register, such that data including a designated number of words is sequentially transferred to an address area starting from the transfer destination start address within a single bus cycle (bus transaction).

FIG. 19 shows a conventional data transfer control system having a PCI bus interface. The PCI bus has a data width of 32 bits, i.e., 4 bytes, and therefore, one word represents the size of 4 bytes. That is, one-word data means 4-byte data. In the case where data is transferred to an address area starting from the transfer destination start address, a burst transfer controlling section 105a causes a burst transfer. The burst transfer controlling section 105a increments the value of a transferred-word number counter 109 every time transfer of one-word data is completed, and each of data is transferred within a single bus cycle till the value of the transferred-word number counter 109 reaches the value stored in a transferred-word number register 106.

FIG. 20A is a timing chart illustrating data transfer from time frame T0 to time frame T11 with a conventional data transfer control system. FIG. 20B is a timing chart illustrating data transfer from time frame T12 to time frame T23 with the conventional data transfer control system. For example, in the case where two pieces of one-word data (Data 1 and Data 2) are respectively transferred to inconsecutive addresses, for example, the 40000000th address and the 40000008th address as shown in FIGS. 20A and 20B, the bus cycle is caused twice to perform a single transfer operation twice, whereby the two pieces of data are transferred to two separate addresses.

In a conventional data transfer control system, a burst transfer cannot be carried out when destination addresses of data are not consecutive, and therefore, high speed data transfer cannot be achieved.

### SUMMARY OF THE INVENTION

An objective of the present invention that was conceived in view of the above is to provide a transfer control method and system which utilize a burst transfer scheme for writing pieces of one-word data in equally-separated address positions so as to achieve high speed data transfer.

A data transfer control system of the present invention is a data transfer control system connected to a bus for controlling a data transfer to a device on the bus, comprising bus cycle control means for performing a data write operation while maintaining a write control line of the bus in a write-disabled state.

Another data transfer control system of the present invention is a data transfer control system connected to a bus for controlling a data transfer to a device on the bus, comprising: data storing means for storing data; transferred-word number storing means for storing the number of words of data which are to be transferred; transfer interval storing means for storing an interval between destination addresses for one-word data; and bus cycle controlling means for controlling the data transfer such that, during a burst transfer, a write control line of the bus is placed in a write-enabled state with the interval stored in the transfer interval storing means and is placed in a write-disabled state in the other periods, and that data including a number of words which is equal to the number stored in the transferred-word number storing means is transferred while the write control line is in the write-enabled state.

Preferably, the data transfer control system further comprises: cycle start address storing means for storing a start address of a bus cycle; resumption address calculating means for calculating a destination address of second data when being informed by the device about interruption of the data transfer during the time when the data transfer is performed in the write-disabled state; and interrupted-cycle resuming means for transferring the address calculated by the resumption address calculating means to the cycle start address storing means to start a new bus cycle from the address stored in the cycle start address storing means when being informed by the device about interruption of the data transfer during the time when the data transfer is performed in the write-disabled state.

Preferably, the data transfer control system further comprises: response speed storing means for storing a device response speed of a target device; transfer speed comparing means for comparing the data transfer rate in a burst transfer mode with the data transfer rate in a data transfer mode where transfer of one-word data to a destination address is repeated, based on the values of the transfer interval storing means and the response speed storing means; and transfer mode selecting means for selecting the burst transfer mode if the data transfer rate is faster in the burst transfer mode than in the data transfer mode where transfer of one-word data to a destination address is repeated and, if otherwise, selecting the data transfer mode where one-word data transfer bus cycle for a destination address is repeated.

Preferably, the bus cycle controlling means drives next one-word data to be transferred onto a data line when the write control line is in the write-disabled state.

Still another data transfer control system of the present invention is a data transfer control system comprising bus response means for informing, when a data write operation is performed while a write control line of a bus is in a write-disabled state, reception of data earlier than in the case where the write control line is in a write-enabled state.

Still another data transfer control system of the present invention is a data transfer control system comprising: storing means for storing an interval between destination addresses of data; and controlling means for obtaining, when a data write operation is performed while a write control line of a bus is in a write-disabled state, a next address where the write control line is turned into a write-enabled state based on a value stored in the storing means to write a value of a signal driven onto a data line in the obtained address.

Still another data transfer control system of the present invention is a data transfer control system connected to a bus for controlling a data transfer to a device on the bus, comprising: data storing means for storing data; transferred-word number storing means for storing the number of words of data which are to be transferred; non-transfer interval storing means for storing an interval between addresses to which the data is not to be transferred; bus cycle controlling means for controlling the data transfer such that, during a burst transfer, a write control line of the bus is placed in a write-disabled state with the interval stored in the non-transfer interval storing means and is placed in a write-enabled state in the other periods, and that data including a number of words which is equal to the number stored in the transferred-word number storing means is transferred while the write control line is in the write-enabled state.

A data transfer control method of the present invention is a data transfer control method for controlling a data transfer to a device on a bus, comprising: a data storing step of storing data; a transferred-word number storing step of storing the number of words of data which are to be transferred; a transfer interval storing step of storing an interval between data destination addresses; and a bus cycle controlling step of controlling the data transfer such that, during a burst transfer, a write control line of the bus is placed in a write-enabled state with the interval stored at the transfer interval storing step and is placed in a write-disabled state in the other periods, and that data including a number of words which is equal to the number stored at the transferred-word number storing step is transferred while the write control line is in the write-enabled state.

As described above, according to a data transfer control system of the present invention, in the case where data including a plurality of words is transferred to addresses which are equally-separated with an interval equal to or smaller than a predetermined interval on a one-word by one-word basis, a data write operation which is performed while a write control line of the bus is placed in a write-disabled state is inserted between two transfer operations of one-word data in inconsecutive destination addresses. With such a feature, data transfer is achieved based on a burst transfer scheme, and it is possible to transfer data at high speed as compared with a data transfer mode where a single transfer operation is repeated.

In the case where interruption of a data transfer is informed during the time when a data write operation is performed while the write control line of the bus is in a write-disabled state, a new bus cycle is started from a next address to which data is to be transferred to carry out transfer of second data. With such a feature, an unnecessary data phase is omitted, and data transfer is achieved at high speed.

In the case where first data and second data whose destination addresses are inconsecutive are sequentially transferred, the time required for the data transfer is compared between a first data transfer mode and a second data transfer mode: in the first data transfer mode, a data write operation that is performed while the write control line of the bus is placed in a write-disabled state is inserted between the data transfer operations of the first and second data; and in the second data transfer mode, a bus cycle is once ended after the first data is transferred, and a new bus cycle is started from a next address to which data is to be transferred to transfer the second data. The data transfer is performed using one of these data transfer mode which requires a shorter data transfer time. With such a feature, it is always possible to select the fastest data transfer mode.

When the write control line is in the write-enabled state, a master device drives next data to be transferred onto a data line, and a target device receives the data prior to the other data. With such a feature, the data transfer rate is increased.

### BRIEF DESCRIPTION OF THE DRAWINGS

FIG. 1 shows a data transfer control system of embodiment 1.

FIG. 2 is a flowchart illustrating an operation of the control system shown in FIG. 1.

FIGS. 3A and 3B show a timing chart for the control system shown in FIG. 1.

FIG. 4 is a memory map of the control system shown in FIG. 1.

FIG. 5 shows a data transfer control system of embodiment 2.

FIG. 6 is a flowchart illustrating an operation of the control system shown in FIG.5.

FIG. 7 is a timing chart for the control system shown in FIG. 5.

FIGS. 8A and 8B shows a timing charts for illustrating effects of embodiment 2.

FIG. 9 shows a data transfer control system of embodiment 3.

FIG. 10 is a timing chart for the control system shown in FIG. 9.

FIG. 11 is a timing chart for illustrating effects of embodiment 3.

FIG. 12 shows a data transfer control system of embodiment 4.

FIG. 13 is a timing chart for the control system shown in FIG. 12.

FIG. 14 is a timing chart for illustrating effects of embodiment 4.

FIG. 15 shows a data transfer control system of embodiment 5.

FIG. 16 is a timing chart for the control system shown in FIG. 15.

FIG. 17 shows a data transfer control system of embodiment 6.

FIG. 18 is a timing chart for the control system shown in FIG. 17.

FIG. 19 shows a conventional data transfer control system.

FIGS. 20A and 20B show a timing chart for the control system shown in FIG. 19.

### DESCRIPTION OF THE PREFERRED EMBODIMENTS

Hereinafter, embodiments of the present invention will be described in detail with reference to the drawings. It should be noted that, in the drawings, identical or equivalent elements are denoted by the same reference numerals, and descriptions thereof are not repeated.

### Embodiment 1

In a data transfer control system described in embodiment 1, data including a plurality of words is transferred at high speed in a burst transfer mode even when the data is transferred to equally-separated addresses on a one-word by one-word basis. Specifically, in the first place, a burst transfer is started from the first address in which the data is to be written. The bus is kept in a write-disabled state during a designated clock cycle. Thereafter, the bus is placed in a write-enabled state at a timing to write the data. Then, again, the bus is placed in a write-disabled state during a designated clock cycle. This operation is repeated till the transfer of the entire data is completed. With such an operation, burst transfer of the data to the equally-separated addresses is achieved.

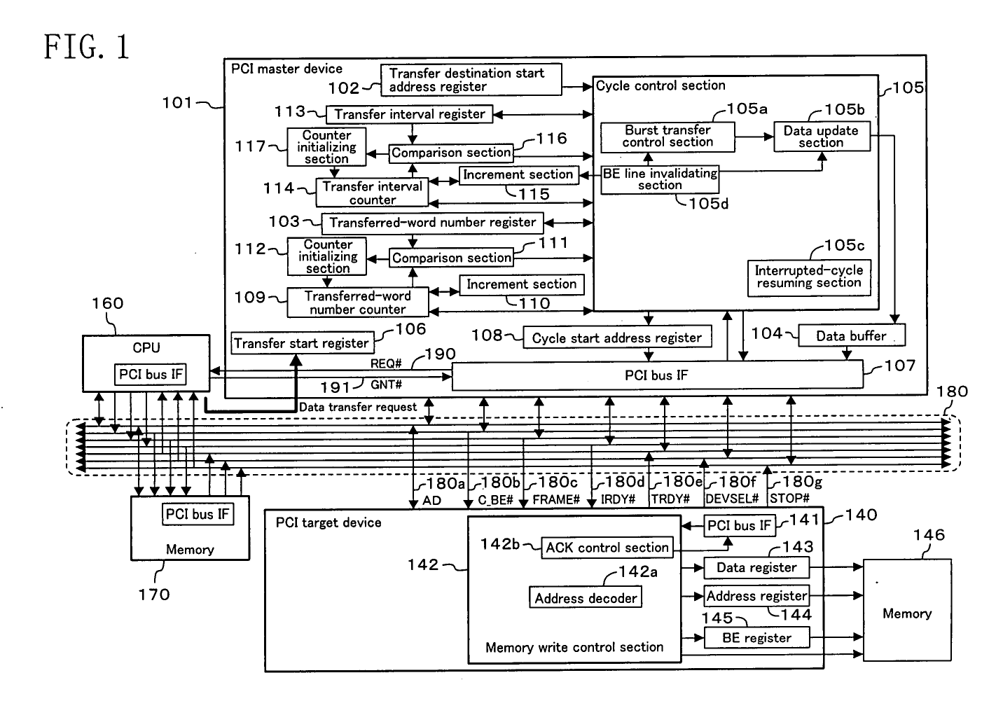

FIG. 1 shows a data transfer control system according to embodiment 1 of the present invention.

A master device 101 of a PCI local bus (hereinafter, “PCI bus”) supports a so-called burst transfer wherein data including a plurality of words is transferred to consecutive addresses in a single bus cycle. When a write operation occurs in a transfer start register 106, a part of the data stored in a data buffer 104, which corresponds to the number of words set in a transferred-word number register 103, is burst-transferred to a memory area starting from a start address of a destination of a burst transfer which is set in a transfer destination start address register 102. After the first data transfer is completed in this burst transfer process, all of the bits which enable/disable writing of data through 4 bytes of a command-byte enable line (C_BE# line) 180b of a PCI bus 180 are each set to 1, i.e., an invalid state, during the period designated by a value stored in a transfer interval register 113. In this way, a PCI target device 140 is inhibited from writing data in a memory 146. Thereafter, all of the bit values of the C_BE# line 180b are set to 0 for transferring the second data. After the transfer of the second data, all of the bit values of the C_BE# line 180b are set to 1 during the period designated by the value stored in the transfer interval register 113. This process is repeated till the data including a number of words which is designated by the transferred-word number register 103 is entirely transferred.

The start address of a destination of a burst transfer can be set in the transfer destination start address register 102 through a CPU 160 by using software.

The number of words of data which is to be transferred can be set in the transferred-word number register 103 through a CPU 160 by using software.

The data buffer 104 retains data to be transferred to the PCI target device 140. From the data buffer 104, an amount of data which corresponds to the number of words designated by the transferred-word number register 103 is read out in one transfer operation. During a PCI bus cycle, leading data of the data read from the data buffer 104 is driven onto an AD line 180a.

When an instruction of starting a transfer is written in the transfer start register 106, a cycle control section 105 requests a right of using the PCI bus 180 through a bus request signal line 190 and obtains the right of using the PCI bus 180 by assertion of a bus grant signal line 191. After obtaining the right of using the PCI bus 180, the cycle control section 105 starts a burst transfer using a burst transfer control section 105a. In the first place, in an address phase, the address set in the transfer destination start address register 102 is driven onto the AD line 180a through a cycle start address register 108. Next, in the first data phase, the first data stored in the data buffer 104 is driven onto the AD line 180a. After the data transfer is completed, the value of a transferred-word number counter 109 is incremented using an increment section 110, the value of the cycle start address register 108 is incremented, a transfer interval counter 114 is incremented using an increment section 115, and the first data is deleted from the data buffer 104. If the value of the transferred-word number counter 109 is equal to the value of the transferred-word number register 103, the transferred-word number counter 109 and the transfer interval counter 114 is initialized to 0, thereby ending the process. If not equal, the value of the transfer interval counter 114 is compared with the value of the transfer interval register 113 using a comparison section 116. If the compared values are equal to each other, the transfer interval counter 114 is initialized to 0 using the counter initializing section 117. Then, in the second data phase, if the value of the transfer interval counter 114 is at the initial value, i.e., 0, the C_BE# line 180b is set to the valid value. After the data transfer is completed, the value of the transferred-word number counter 109 is incremented using an increment section 110, the value of the cycle start address register 108 is incremented, the transfer interval counter 114 is incremented using the increment section 115, and the second data is deleted from the data buffer 104 to update the data buffer 104. When receiving from a comparison section 111 a notice that the values of the transferred-word number counter 109 and the transferred-word number register 103 are equal, the transferred-word number counter 109 and the transfer interval counter 114 are initialized to 0, thereby ending the transfer process. If the value of the transfer interval counter 114 is not the initial value of 0, a BE# line invalidating section 105d sets all of the bits of the C_BE# line 180b to 1, i.e., the invalid value. After the data transfer is completed, the value of the cycle start address register 108 is incremented, and the transfer interval counter 114 is incremented using the increment section 115. Then, in the third and subsequent data phases, the same operation as that performed in the second data phase is repeated till the number of words of the data transferred while all of the bits of the C_BE# line 180b are 0 reaches the value of the transferred-word number register 103. If the burst transfer is interrupted by the target device 140, an interrupted-cycle resuming section 105c controls a cycle control section 105 such that the interrupted cycle is resumed after a wait of 2 clock cycles.

A burst transfer control section 105a controls a burst transfer to the PCI bus 180.

After transfer of data the writing of which is valid is completed, a data update section 105b deletes the transferred data from the data buffer 104 to update the data stored in the data buffer 104. The updated data is output onto the bus.

When a bus cycle is interrupted by the PCI target device 140, the interrupted-cycle resuming section 105c resumes the bus cycle through a PCI bus interface 107 after a wait of 2 clock cycles.

When the value of the transfer interval counter 114 is not 0 in a data phase, the BE# line invalidating section 105d sets all of the bits of the C_BE# line 180b to the invalid value, i.e., 1. When this data phase ends, the BE# line invalidating section 105d instructs the data update section 105b not to update the data of the data buffer 104.

When an instruction to start a transfer is written in the transfer start register 106, the cycle control section 105 starts a burst transfer.

The PCI bus interface 107 controls the PCI bus 180 on behalf of the PCI master device 101.

When a burst transfer is started, the value of the transfer destination start address register 102 is copied to the cycle start address register 108. When the burst transfer to the PCI target device 140 is disconnected, the cycle start address register 108 stores an address from which a bus cycle is to be resumed.

The transferred-word number counter 109 counts the number of words of transferred data.

When the burst transfer is completed, the increment section 110 initializes the transferred-word number counter 109.

The comparison section 111 compares the value of the transferred-word number counter 109 with the value of the transferred-word number register 103. If these values are equal, the number of words of data to be transferred is equal to the number of words of data which has already been transferred. This information is transmitted by the comparison section 111 to the cycle control section 105, and a counter initializing section 112 is employed to initialize the transferred-word number counter 109. If the value of the transferred-word number counter 109 is smaller than that of the transferred-word number register 103 by 1, the comparison section 111 informs only the cycle control section 105 about it. When being informed by the comparison section 111 that the value of the transferred-word number counter 109 is equal to the value of the transferred-word number register 103, the cycle control section 105 instructs the PCI bus interface 107 to end a PCI bus cycle. When being informed that the value of the transferred-word number counter 109 is smaller than the value of the transferred-word number register 103 by 1, the cycle control section 105 instructs the PCI bus interface 107 to deassert a FRAME# line 180c, thereby ending the burst transfer in the next data phase.

When the comparison section 111 determines that the value of the transferred-word number register 103 is equal to the value of the transferred-word number counter 109, the counter initializing section 112 initializes the transferred-word number counter 109.

The interval between destination addresses to which data is to be transferred can be set in the transfer interval register 113 through a CPU 160 by using software. For example, in the case where a data transfer process wherein writing does not occur for consecutive n words is performed after a data transfer process wherein one-word data is written, the value of the transfer interval register 113 is (n+1).

The transfer interval counter 114 counts the number of words of data which is not written after writing of one-word data. The value of the transfer interval counter 114 is incremented by the increment section 115 every time a data phase is completed during a burst transfer. When the value of the transfer interval counter 114 reaches the value of the transfer interval register 113, or when the bus cycle is completed, the initial value of 0 is written in the transfer interval counter 114 by the counter initializing section 117. If the value of the transfer interval counter 114 is 0, the cycle control section 105 sets the valid value in the C_BE# line 180b, and data is transferred.

The increment section 115 increments the value of the transfer interval counter 114 every time a data phase is completed during the burst transfer.

The comparison section 116 compares the value of the transfer interval counter 114 with the value of the transfer interval register 113. If these values are equal, the comparison section 116 informs the cycle control section 105 and the counter initializing section 117 about it. If the value of the transfer interval counter 114 is smaller than the value of the transfer interval register 113 by 1, the comparison section 116 informs only the cycle control section 105 about it.

When being informed by the comparison section 116 that the value of the transfer interval register 113 is equal to the value of the transfer interval counter 114, the counter initializing section 117 initializes the transfer interval counter 114 to 0.

When receiving data from the PCI master device 101 through the PCI bus 180, the PCI target device 140 stores the data in the memory 146 except when all of the bits of the C_BE# line 180b are 1 in each data phase of the PCI bus cycle.

A PCI bus interface 141 controls the PCI bus 180 on behalf of the PCI target device 140. Herein, assertion of TRDY# 180e is performed after an acknowledgement signal is received from an acknowledgement signal control section 142b.

A memory write control section 142 controls writing of data from the PCI bus 180 to the memory 146.

An address decoder 142a takes in and decodes the value driven onto the AD line 180a in an address phase of the PCI bus 180 to check whether or not it is the address allocated to the PCI target device 140. If so, the address decoder 142a instructs the PCI bus interface 141 to respond to the PCI bus cycle and, on the other hand, instructs the memory write control section 142 to perform a write operation on the memory 146.

After writing of data by the memory write control section 142 in the memory 146 is completed, the acknowledgement signal control section 142b sends an acknowledgement signal to the PCI bus interface 141.

A data register 143 temporarily stores data transferred from the PCI bus 180 before it is written in the internal memory 146.

An address register 144 stores an address corresponding to each data phase of the PCI bus 180.

A byte enable register 145 stores a 4-bit value. For example, when a 4-byte data is written in the memory 146, the byte enable register 145 functions such that the data is written only in a byte position where each bit corresponding to each byte is 0.

The memory 146 stores the data which has been transferred from the PCI master device 101 and temporarily stored in the data register 143, in an address position designated by the value of the address register 144, according to the value stored in the byte enable register 145.

The CPU 160 uses a memory 170 as a main memory. In the case where a burst transfer from the PCI master device 101 to the PCI target device 140 is performed, a transfer start address is set in the transfer destination start address register 102, a transfer interval is set in the transfer interval register 113, the number of words to be transferred is set in the transferred-word number register 103, and in the last, an instruction to start the transfer is written in the transfer start register 106, before the burst transfer is started.

The memory 170 is used as a main memory of the CPU 160.

The PCI bus 180 has a 32-bit address-data line (AD line) 180a, a 4-bit command-byte enable line (C_BE# line) 180b, a 1-bit frame line (FRAME# line) 180c, an initiator-ready line (IRDY# line) 180d, a target-ready line (TRDY# line) 180e, a device-select line (DEVSEL# line) 180f, and a stop line (STOP# line) 180g. The PCI bus 180 is connected to the PCI master device 101, the PCI target device 140, the CPU 160 and the memory 170.

The bus request line 190 is a signal line through which the PCI master device 101 requests from the CPU 160 a bus use right for the PCI bus 180

The bus grant line 191 is a signal line through which the CPU 160 grants the PCI master device 101 the bus use right for the PCI bus 180.

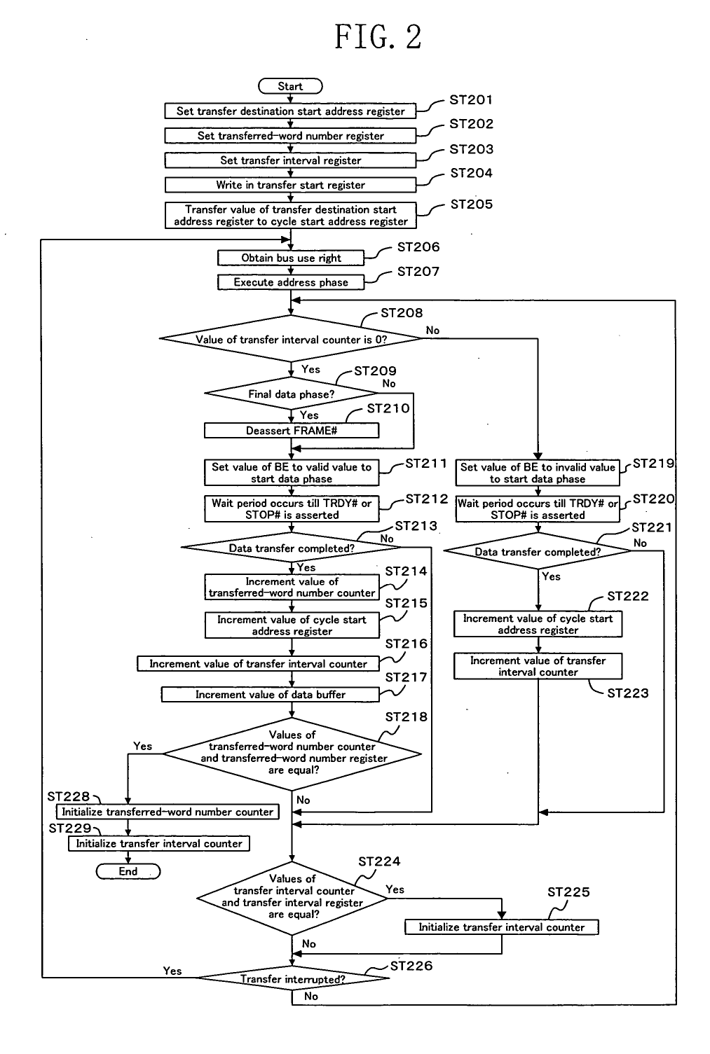

FIG. 2 is a flowchart illustrating an operation of the control system of embodiment 1.

At step ST201, the transfer destination start address register 102 is set by the CPU 160 through the PCI bus 180, and the process proceeds to step ST202.

At step ST202, the transferred-word number register 103 is set by the CPU 160 through the PCI bus 180, and the process proceeds to step ST203.

At step ST203, the transfer interval register 113 is set by the CPU 160 through the PCI bus 180, and the process proceeds to step ST204.

At step ST204, the transfer start register 106 is written by the CPU 160 through the PCI bus 180, and the process proceeds to step ST205.

At step ST205, the value of the transfer destination start address register 102 is transferred to the cycle start address register 108 by the cycle control section 105, and the process proceeds to step ST206.

At step ST206, the PCI master device 101 asserts the bus request line 190 to request from the CPU 160 the bus use right for the PCI bus 180. The CPU 160 asserts the bus grant line 191 to grant the PCI master device 101 the bus use right, whereby the PCI master device 101 obtains the bus use right for the PCI bus 180. Then, the process proceeds to step ST207.

At step ST207, a PCI bus cycle is started by the PCI bus interface 141 to execute an address phase. The value of the cycle start address register 108 is driven as an address onto the AD line 180a of the PCI bus interface 180, and a memory write command is issued to the C_BE# line 180b. Then, the process proceeds to step ST208.

At step ST208, the cycle control section 105 determines whether or not the value of the transfer interval counter 114 is 0. If it is 0, the process proceeds to step ST209. If it is not 0, the process proceeds to step ST219.

At step ST209, the comparison sections 111 and 116 and the cycle control section 105 determine whether or not it is the final data phase. If it is the final data phase, the process proceeds to step ST210. If not, the process proceeds to step ST211.

At step ST210, the FRAME# line 180c is deasserted by the PCI bus interface 107 to inform that it is the final data phase. Then, the process proceeds to step ST211.

At step ST211, the PCI bus interface 107 sets the C_BE# line 180b to the valid value, and the leading data of the data buffer 104 is driven onto the AD line 180a to execute a data phase. Then, the process proceeds to step ST212.

At step ST212, a wait period occurs till the TRDY# line or STOP# line is asserted by the PCI bus interface 107. When one of these lines is asserted, the process proceeds to step ST213.

If the TRDY# line is asserted at step ST212, the PCI bus interface 107 determines at step ST213 that the data transfer has been completed, and then, the process proceeds to step ST214. If only the STOP# line is asserted but the TRDY# line is not asserted at step ST212, the PCI bus interface 107 determines at step ST213 that the data transfer has not been completed, and then, the process proceeds to step ST224.

At step ST214, the transferred-word number counter 109 is incremented by the increment section 110, and the process proceeds to step ST215.

At step ST215, the cycle control section 105 increments the value of the cycle start address register 108 by 4 bytes which is equal to the bus width of the PCI bus 180, and the process proceeds to step ST216.

At step ST216, the value of the transfer interval counter 114 is incremented by the increment section 115, and the process proceeds to step ST217.

At step ST217, the data that has been transferred is deleted by the data update section 105b from the data buffer 104, and the process proceeds to step ST218.

At step ST218, the comparison section 111 compares the value of the transferred-word number counter 109 with the value of the transferred-word number register 103. If these values are equal, the process proceeds to step ST228. If not, the process proceeds to step ST224.

At step ST219, the BE# line invalidating section 105d and the PCI bus interface 107 set all of the bits of the C_BE# line 180b to the invalid value, i.e., 1. The leading data of the data buffer 104 is driven onto the AD line 180a to execute a data phase. Then, the process proceeds to step ST220.

At step ST220, a wait period occurs till the TRDY# line or STOP# line is asserted. If one of these lines is asserted, the process proceeds to step ST221.

If the TRDY# line is asserted at step ST220, it is determined at step ST221 that the data transfer has been completed, and then, the process proceeds to step ST222. If only the STOP# line is asserted but the TRDY# line is not asserted at step ST220, it is determined at step ST221 that the data transfer has not been completed, and then, the process proceeds to step ST224.

At step ST222, the cycle control section 105 increments the value of the cycle start address register 108 by 4 bytes which is equal to the bus width of the PCI bus 180, and the process proceeds to step ST223.

At step ST223, the value of the transfer interval counter 114 is incremented by the increment section 115, and the process proceeds to step ST224.

At step ST224, the comparison section 116 compares the value of the transfer interval counter 114 with the value of the transfer interval register 113. If these values are equal, the process proceeds to step ST225. If not, the process proceeds to step ST226.

At step ST225, the counter initializing section 117 initializes the transfer interval counter 114, and the process proceeds to step ST226.

At step ST226, if the bus cycle is interrupted by the assertion of the STOP# line 180g, the process returns to step ST206. If not interrupted, the process proceeds to step ST208.

At step ST228, the counter initializing section 112 initializes the transferred-word number counter 109 to 0, and the process proceeds to step ST229.

At step ST229, the counter initializing section 117 initializes the transfer interval counter 114 to 0, whereby the burst transfer process is ended.

Next, an operation of the control system of embodiment 1 is described with reference to exemplary data.

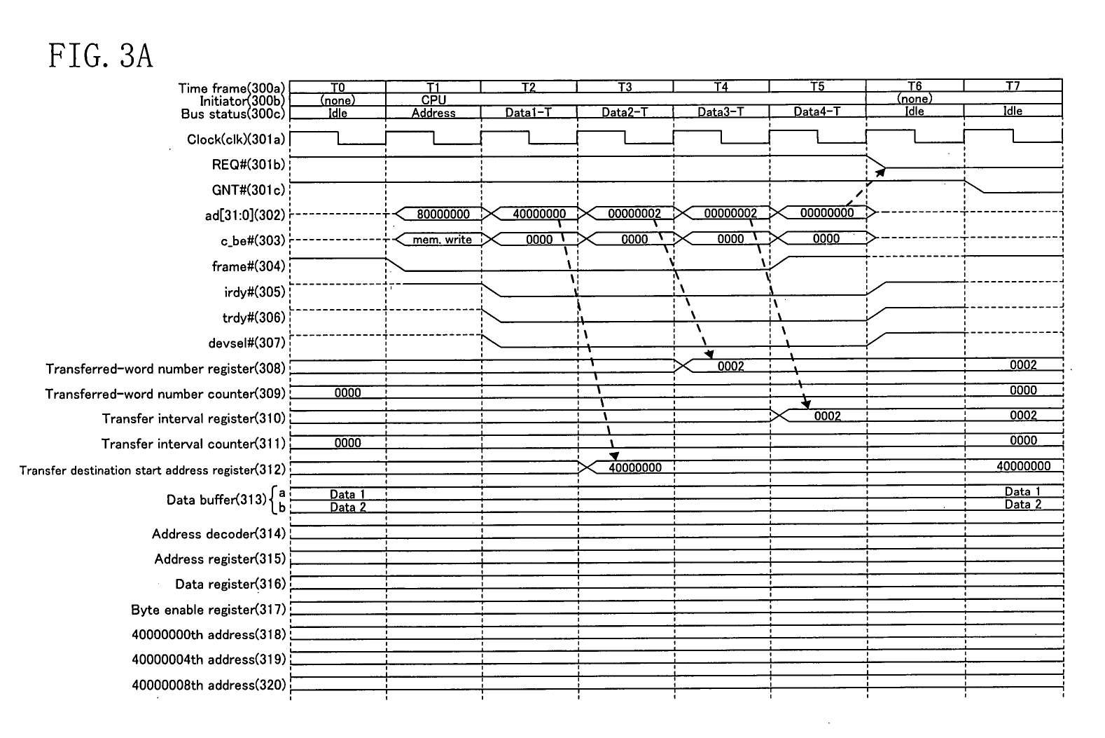

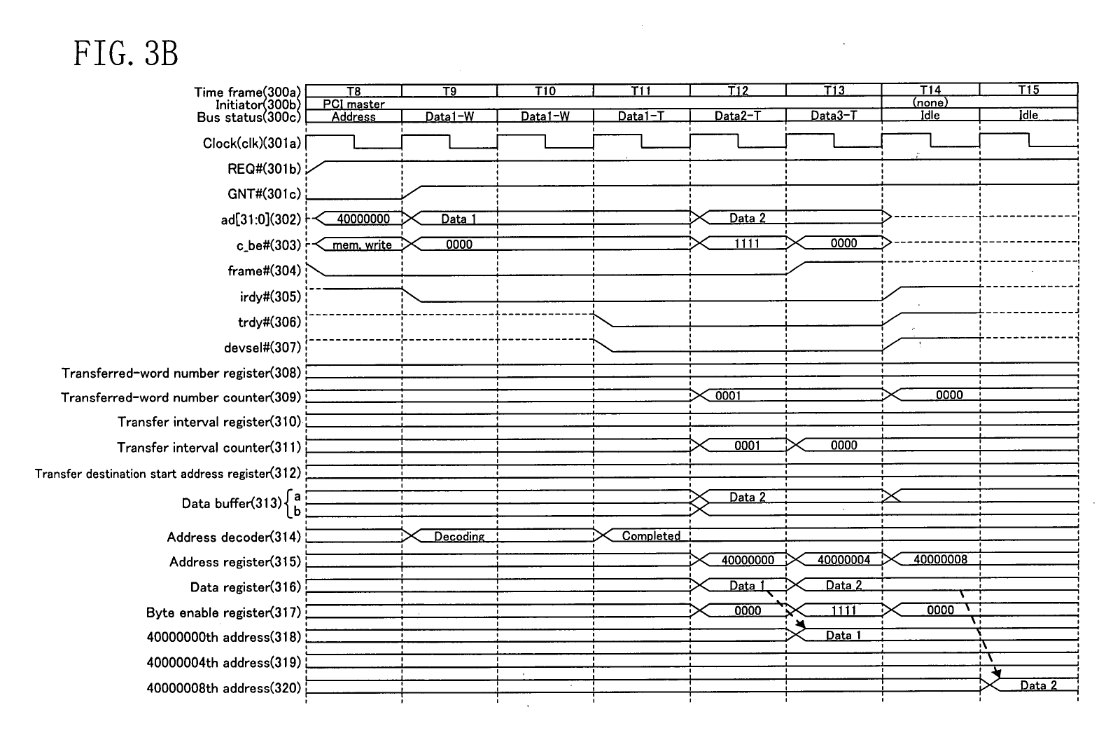

FIGS. 3A and 3B shows a timing chart for a case where Data 1 and Data 2 are transferred to the 40000000th address and the 40000008th address of the memory 146, respectively. FIG. 3A shows the chart of time frame T0 to time frame T11. FIG. 3B shows the chart of time frame T11 to time frame T15. In the example illustrated in FIGS. 3A and 3B, the PCI master device 101 transfers Data 1 and Data 2 to the memory 146 through the PCI target device 140 in a burst transfer mode, such that Data 1 is first transferred to the 40000000th address, Data 2 is then transferred to the 40000004th address while the C_BE# line is set to the invalid value, and in the last, Data 2 is transferred to the 40000008th address.

In FIGS. 3A and 3B, the following reference numerals denote the following particulars:

300a: Time frames determined by units of one clock cycle;

300b: Initiator which performs a bus cycle of the PCI bus 180;

300c: State of the PCI bus 180;

301a: State of a clock line (CLK);

301b: State of the bus request line (REQ#) 190;

301c: State of the bus grant line (GNT#) 191;

302: State of the address-data line (AD line) 180a;

303: State of the command-byte enable line (C_BE# line) 180b;

304: State of the FRAME# line 180c;

305: State of the IRDY# line 180d;

306: State of the TRDY# line 180e;

307: State of the DEVSEL# line 180f;

308: Value of the transferred-word number register 103;

309: Value of the transferred-word number counter 109;

310: Value of the transfer interval register 113;

311: Value of the transfer interval counter 114;

312: Value of the transfer destination start address register 102;

313: Leading two-word data of the data buffer 104;

313a: First word of the leading data of the data buffer 104;

313b: Second word of the leading data of the data buffer 104;

314: State of the address decoder 142a;

315: Value of the address register 144;

316: Value of the data register 143;

317: Value of the byte enable register 145;

318: Value of the 40000000th address of the memory 146;

319: Value of the 40000004th address of the memory 146; and

320: Value of the 40000008th address of the memory 146.

In this example, the PCI target device 140 is a slow decoding device. Specifically, the PCI target device 140 asserts the DEVSEL# line 180f three cycles after the address phase. The memory 146 completes a writing operation within one clock cycle of the PCI bus 180, and accordingly, the acknowledgement signal control section 142b sends an acknowledgement signal to the PCI bus interface 141 without a wait after decoding of an address in the address decoder 142a is completed.

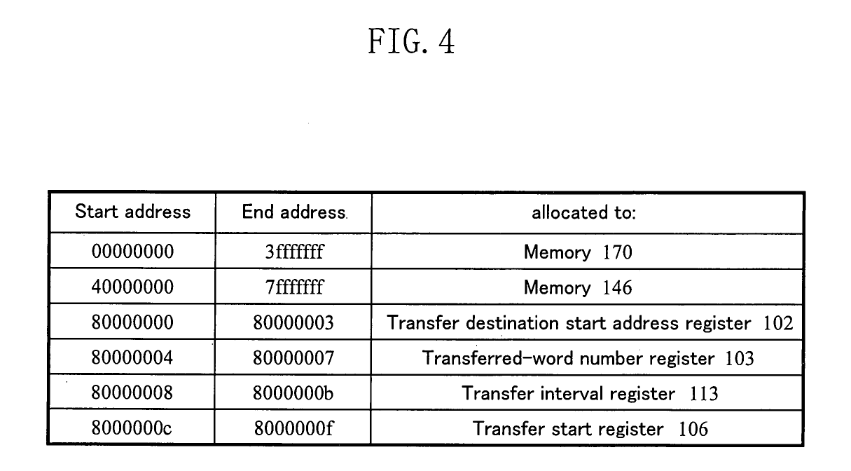

FIG. 4 is a memory map of the memories and registers.

Hereinafter, the operation of the control system is described along the time flow shown in the time frame line 300a with reference to FIGS. 3A and 3B in conjunction with FIGS. 1 and 2.

(Time frame T0)

The PCI bus 180 is in an idle state.

As shown in the part 313, the data buffer 104 stores two pieces of one-word data to be transferred, i.e., Data 1 and Data 2, in this order.

The transferred-word number counter 109 and the transfer interval counter 114 each store the initial value of 0 as shown in the parts 309 and 311, respectively.

(Time frames T1 to T5)

In the process of steps ST201 to ST205, the CPU 160 writes 2 in the transferred-word number register 103 (see the part 308), 2 in the transfer interval register 113 (see the part 310), and 40000000 in the transfer start address register 102 (see the part 312).

(Time frames T6 and T7)

The process proceeds to step ST206. As shown in the parts 301b and 301c, in time frame T6, the REQ# line 190 is asserted to request the use right for the PCI bus 180. In time frame T7, the GNT# line 191 is asserted, whereby the PCI master device 101 obtains the use right.

(Time frame T8)

The process proceeds to step ST207, and the PCI bus 180 enters the address phase. As shown in the parts 302, 303, and 304, the PCI bus interface 107 drives the 40000000th address onto the AD line 180a, drives a memory-write command onto the C_BE# line 180b, and asserts the FRAME# line 180c, thereby starting a bus cycle.

(Time frame T9)

The process proceeds through steps ST208, ST209, and ST210 to reach step ST207, and the PCI bus 180 enters the data phase. In time frame T9, the PCI target device 140 does not yet make a response, and therefore, data transfer is not established.

As shown in the part 314, the address decoder 142a of the PCI target device 140 starts decoding the address value 40000000 which has been driven onto the AD line 180a in time frame T8.

As shown in the parts 302, 303 and 304, the PCI bus interface 107 sets the value of the AD line 180a to Data 1, sets the value of the C_BE# line 180b to 0000, and asserts the IRDY# line 180d.

(Time frame T10)

The process remains at step ST212, and the PCI bus 180 is in the data phase where data transfer is not established.

(Time frame T11)

As shown in the part 314, the address decoder 142a completes decoding of the 40000000th address. The PCI bus interface 141 asserts the TRDY# line 180e and the DEVSEL# line 180f as shown in the parts 306 and 307, respectively, to inform on behalf of the PCI target device 140 that the response and data transfer have been completed.

(Time frame T12)

Since the TRDY# line 180e has been asserted in time frame T11, the process goes through step ST213 to reach step ST214.

At step ST214, the value of the transferred-word number counter 109 is incremented to 1 as shown in the part 309.

Then, the process goes through step ST215 to reach step ST216. At step ST216, the value of the transfer interval counter 114 is incremented to 1 as shown in the part 311.

Then, at step ST217, as shown in the part 313, the leading data, i.e., Data 1, is deleted from the data buffer 104 so that, instead, Data 2 becomes the leading data.

As shown in the part 316, the PCI target device 140 takes Data 1, which has been driven onto the AD line 180a in the previous time frames, into the data register 143. On the other hand, as shown in the part 317, the PCI target device 140 takes the value 0000, which has been driven onto the C_BE# line 180b, into the byte enable register 145. Furthermore, as shown in the part 315, the PCI target device 140 takes the address 40000000 into the address register 144.

Then, the process proceeds through steps ST218, ST224, and ST226 and returns to step ST208. Since the value of the transfer interval counter 114 is not 0 at step ST208, the BE# line invalidating section 105d instructs the burst transfer control section 105a to change the value of the C_BE# line 180b to the invalid value at step ST209. As the invalid value, the value of 1111 is driven onto the C_BE# line 180b as shown in the part 303.

(Time frame T13)

Since the value of the byte enable register 145 is 0000 in the previous frame as shown in the part 317, the memory write control section 142 writes the value of the data register 143, i.e., Data 1, in an address of the memory 146 which is designated by the value stored in the address register 144, i.e., 40000000, as shown in the part 318.

The PCI target device 140 increments the value of the address register 144 to 40000004 and takes Data 2, which has been driven onto the AD line 180a in the previous frame, into the data register 143. The PCI target device 140 takes the value of 1111, which has been driven onto the C_BE# line 180b, into the byte enable register 145.

The PCI bus interface 141 of the PCI target device 140 continues the assertion of the TRDY# line 180e, thereby informing the PCI master device 101 that the final data phase ends in this time frame.

The process proceeds through steps ST220, ST221, and ST222 to reach step ST223. At step ST223, in the PCI master device 101, the value of the transfer interval counter 114 is incremented. Then, at step ST224, the comparison section 116 compares the value of the transfer interval counter 114, i.e., 2, with the value of the transfer interval register 113, i.e., 2. Since these values are equal, the process proceeds to step ST225. At step ST225, the counter initializing section 117 initializes the transfer interval counter 114 to 0 as shown in the parts 311.

The process proceeds through step ST226 and returns to step ST208. Since the value of the transfer interval counter 114 is 0, the process then proceeds to step ST209. Since this data phase is the final data phase, the FRAME# line 180c is deasserted at step ST210 as shown in the part 304, and information that the current data phase is the final data phase is sent to the PCI target device 140.

Then, at step ST211, as shown in the parts 302 and 303, respectively, the PCI bus interface 107 drives Data 2 onto the AD line 180a and the value of all 0, i.e., “0000”, onto the C_BE# line 180b.

(Time frame T14)

Since the value of the byte enable register 145 is 1111 in the previous time frame, the memory write control section 142 writes no data in an address designated by the value stored in the address register 144, i.e., 40000004.

The PCI target device 140 increments the value of the address register 144 to 40000008 and takes Data 2, which has been driven onto the AD line 180a in the previous time frame, in the data register 143. Furthermore, the PCI target device 140 takes the value of 0000, which has been driven onto the C_BE# line 180b, in the byte enable register 145.

Since the TRDY# line 180e has been asserted in the previous time frame as shown in the part 306, the process proceeds through steps ST212, ST213, ST214, ST215 and ST216 to reach step ST217. The PCI master device 101 increments the transferred-word number counter 109 to 2 and deletes Data 2 from the data buffer 104. Since the value of the transferred-word number register 103 and the value of the transferred-word number counter 109 are equal at step ST218, the process proceeds to steps ST228 and ST229. At these steps, the transferred-word number counter 109 and the transfer interval counter 114 are each initialized to 0 as shown in the parts 309 and 311, respectively.

(Time frame T15)

Since the value of the byte enable register 145 is 0000 in the previous time frame, the memory write control section 142 writes the value of the data register 143, i.e., Data 2, in an address of the memory 146 which is designated by the value retained in the address register 144, i.e., 40000008, as shown in the part 320.

Since the cycle control section 105 performs a burst transfer while setting the C_BE# line 180b to the invalid value, the PCI master device 101 of embodiment 1 can transfer data to equally-separated addresses at high speed by repeating the above operation.

### Embodiment 2

In the structure of the PCI master device of embodiment 1, if data transfer is interrupted by disconnect termination from a target device during a burst transfer, the interrupted transfer is resumed from an address which was in process at the time of interruption. However, if the address from which the transfer is resumed is an address in which no data is to be written, an unnecessary data phase is executed at the time of resuming the transfer. A PCI master device described in embodiment 2, which was conceived in view of the above problem, includes in addition to the structure of embodiment 1 the function of resuming a data transfer from an address where a next effective data transfer is to be performed.

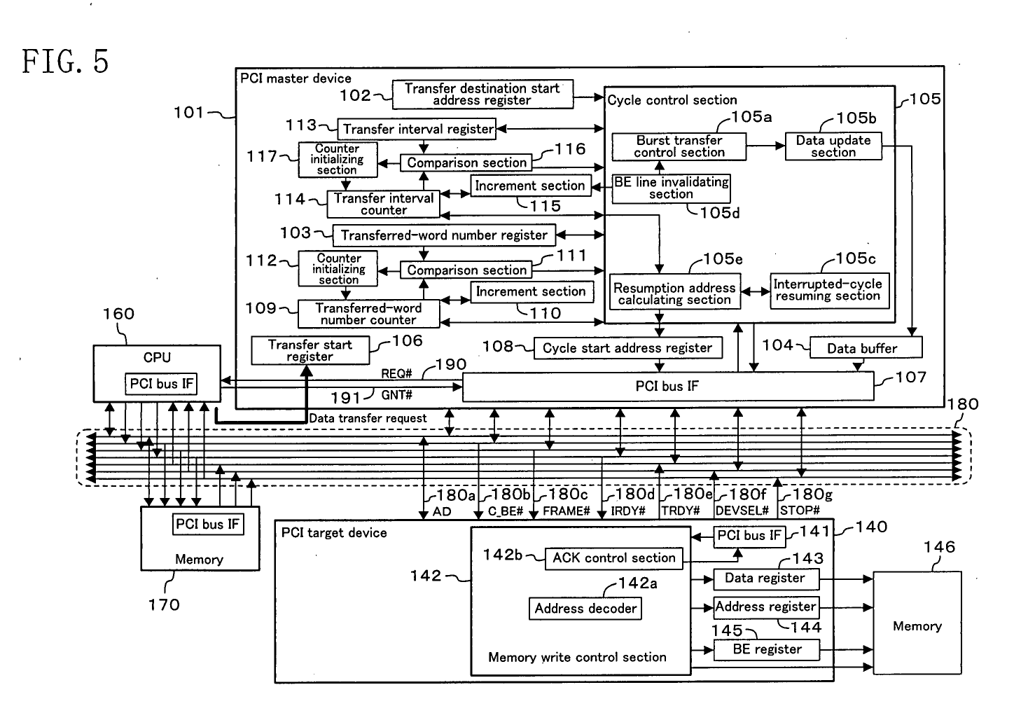

FIG. 5 shows a data transfer control system according to embodiment 2 of the present invention. In FIG. 5, reference numeral 105e denotes a resumption address calculating section. When a data transfer is interrupted by a target device during a burst transfer, the resumption address calculating section 105e calculates a next address to which valid data is to be transferred and writes the calculated address in the cycle start address register 108. This address is obtained by the calculation of (Value of cycle start address register)+((Value of transfer interval register)−(Value of transfer interval counter))×4.

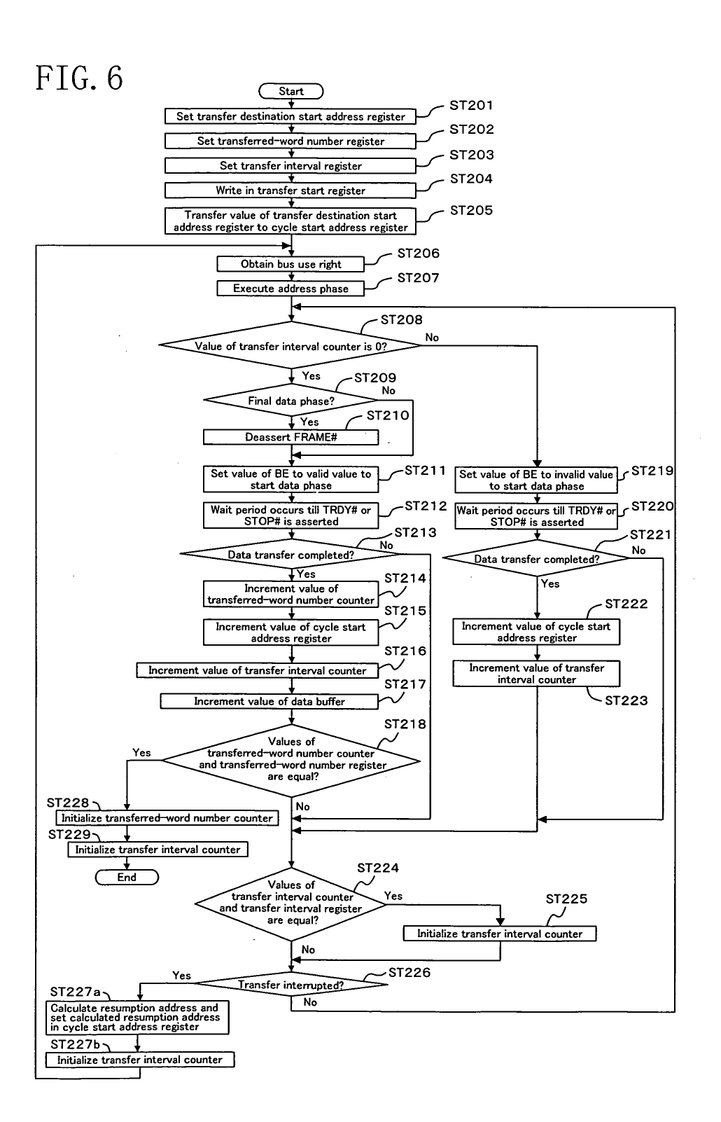

FIG. 6 is a flowchart illustrating an operation of the control system of embodiment 2. The flowchart of embodiment 2 is different from that of embodiment 1 in that the processes of steps ST227a and ST227b are added in the course of returning from step ST226 to step ST206.

At step ST226, if a bus cycle is interrupted by the assertion of the STOP# line 180g, the process proceeds to steps ST227a. If not, the process proceeds to steps ST208.

At step ST227a, a next address to which valid data is to be transferred is calculated, and the calculated address is set in the cycle start address register 108. Then, the process proceeds to step ST227b.

At step ST227b, the transfer interval counter 114 is initialized, and the process returns to step ST206.

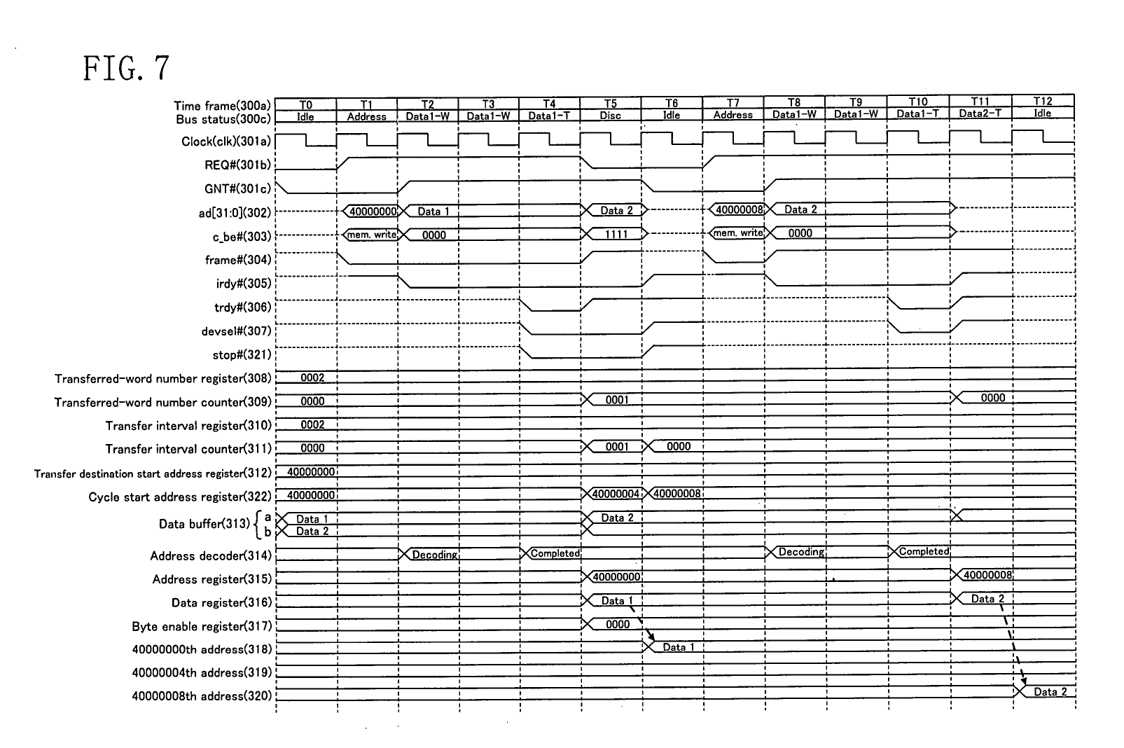

FIG. 7 is a timing chart illustrating an exemplary operation of the control system of embodiment 2. In FIG. 7, a part 321 shows the state of the STOP# line 180g, and reference numeral 322 denotes the value of the cycle start address register 108.

In time frame T4, as shown in the part 321, the STOP# line 180g is asserted, and a disconnect response comes from the PCI target device. Thus, at the next time frame T5, as shown in the part 304, the FRAME# line 180c is deasserted to perform a termination process of a bus cycle. Herein, since the value of the transfer interval counter 114 is 1 as shown in the part 311, the resumption address calculating section 105e calculates a next valid address, at next time frame T6, as follows:

40000004+(2−1)×4.

The resumption address calculating section 105e transfers the result value, 40000008, to the cycle start address register 108 as shown in the part 322.

After the bus cycle is resumed, a data transfer is started from the destination address of 40000008 of an effective data transfer, as indicated by the value of the AD line 180a in time frame T7, with the leading data of the data stored in the data buffer 104 which would have been written next at the time of interruption of the data transfer.

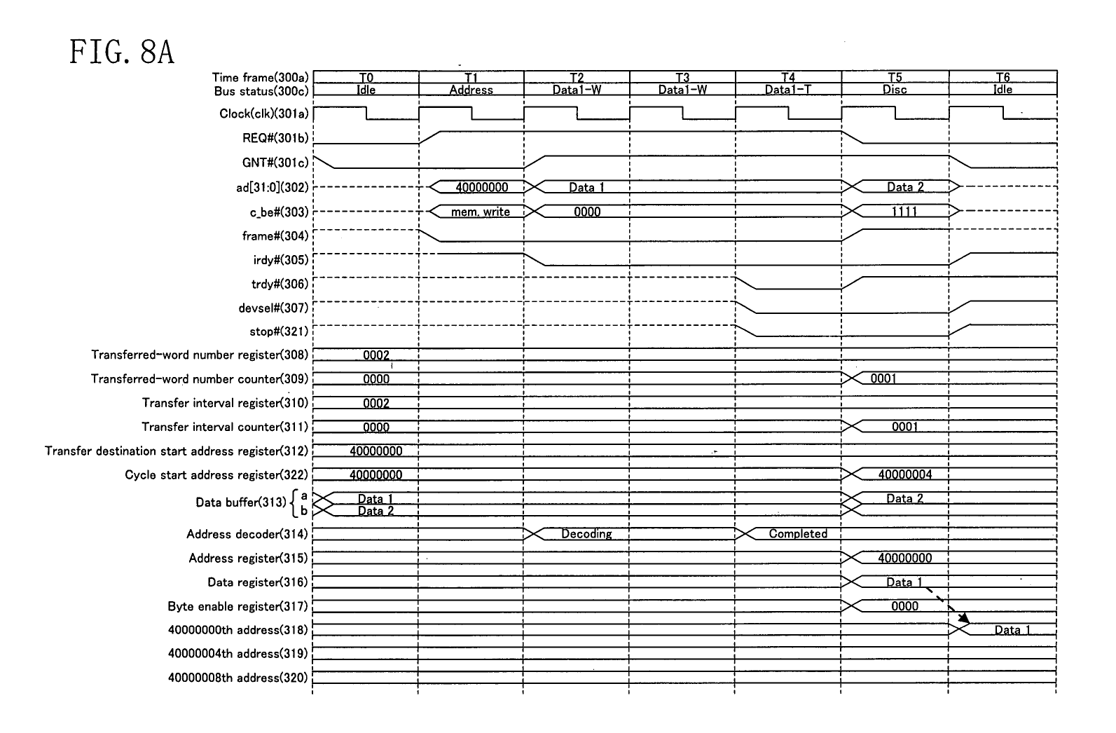

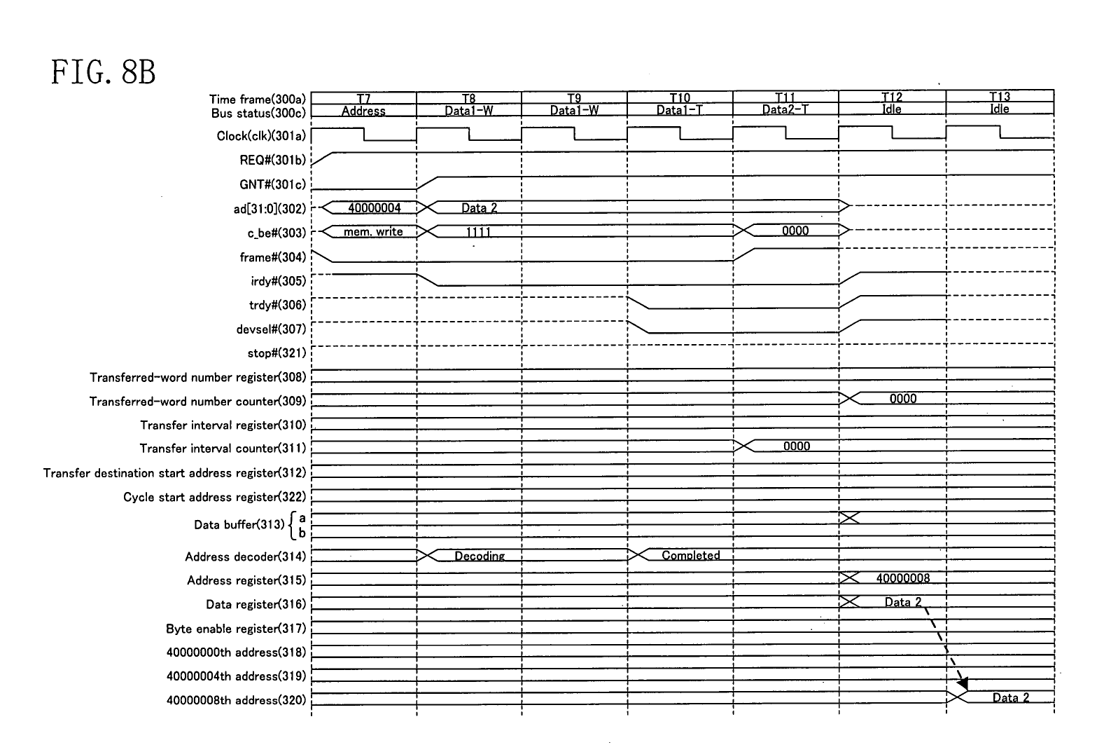

If the resumption address calculating section 105e is not provided, the data transfer is resumed while the value of the C_BE# line 180b is invalid, i.e., 1111, as shown in FIGS. 8A and 8B (see time frame T8). Thus, the timing of storing Data 2 in address 40000008 is time frame T13, i.e., is delayed by one clock cycle.

In the above-described PCI master device 101 of embodiment 2, if a data transfer is interrupted, a bus cycle is resumed from a data phase in which next data to be transferred is transferred, and therefore, the data transfer is achieved at higher speed.

### Embodiment 3

In the structure of the PCI master device of embodiment 1, the data transfer rate decreases as the interval between destination addresses increases. In such a case, the data transfer rate is increased by employing the following data transfer method. A bus cycle is ended every time data transfer of one word is completed. Immediately after the end of the bus cycle, the process jumps to a next address to which data is to be transferred, and the bus cycle is resumed from the address. This process is repeated till all the data is transferred. A PCI master device of embodiment 3 always selects one of this data transfer method and the data transfer method of embodiment 1 which achieves a faster data transfer.

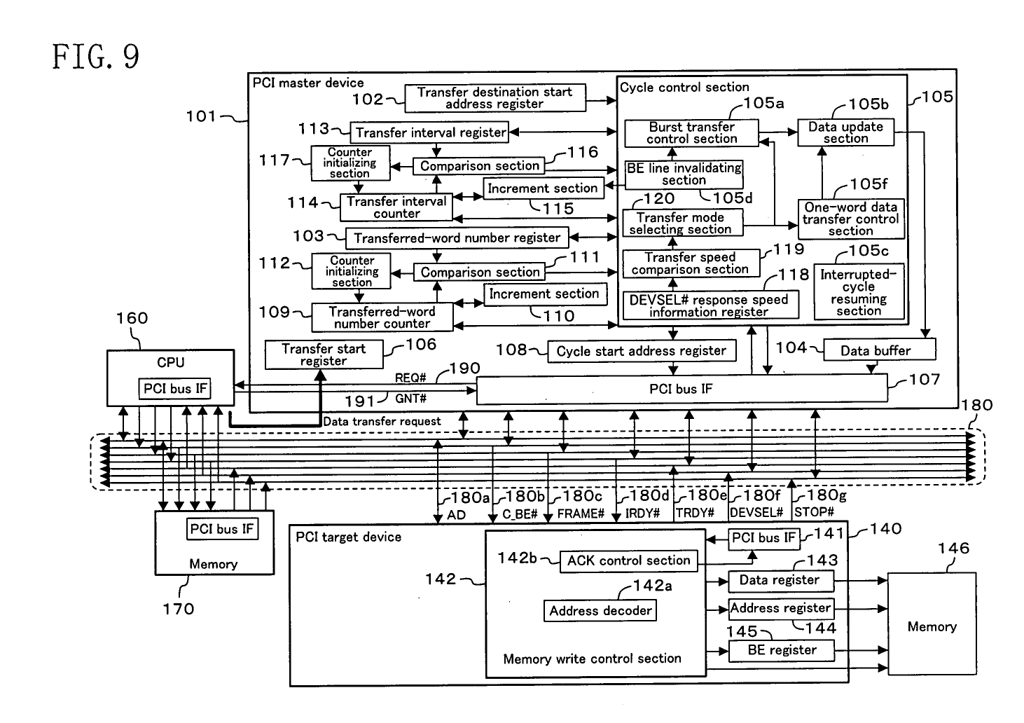

FIG. 9 shows a data transfer control system according to embodiment 3 of the present invention. In FIG. 9, reference numeral 105f is a one-word data transfer control section. If a transfer mode selecting section 120 determines that entire data is transferred on a one-word by one-word basis in separate bus cycles, the one-word data transfer control section 105f causes a bus cycle for transferring one-word data (hereinafter, “one-word data transfer bus cycle”) a number of times equal to the number of words to be transferred which is stored in the transferred-word number register 103. Considering that the PCI bus 180 is a 32-bit bus, i.e., a bus having a 4-byte width, the destination addresses are separated with intervals of the value obtained by the following expression:

(Value of the transfer interval register 113)×4.

Thus, as for the second and subsequent addresses, the destination address value of the next cycle is obtained by adding the value obtained by the above expression to the value of the cycle start address register 108.

In a DEVSEL# response information register 118, a value is set according to the response speed of the DEVSEL# line 180f of the target device 140. In the case where the DEVSEL# line 180f is asserted in the next time frame of the address phase, i.e., in the case where the response is “FAST”, a delay between one-word data transfer bus cycles due to a delayed response of the DEVSEL# line 180f does not occur. Thus, 0 (zero) is set in the DEVSEL# response information register 118. In the case where the response speed is delayed by one clock cycle with respect to the high response speed, i.e., in the case where the response is “MEDIUM”, the delay of one clock cycle occurs between one-word data transfer bus cycles. Thus, 1 is set in the DEVSEL# response information register 118. In the case of the “SLOW” response speed which is slower by one more clock cycle, 2 is set in the DEVSEL# response information register 118. In the case of a subtractive decoding device where the response speed is still slower by another clock cycle than the low response speed, 3 is set in the DEVSEL# response information register 118.

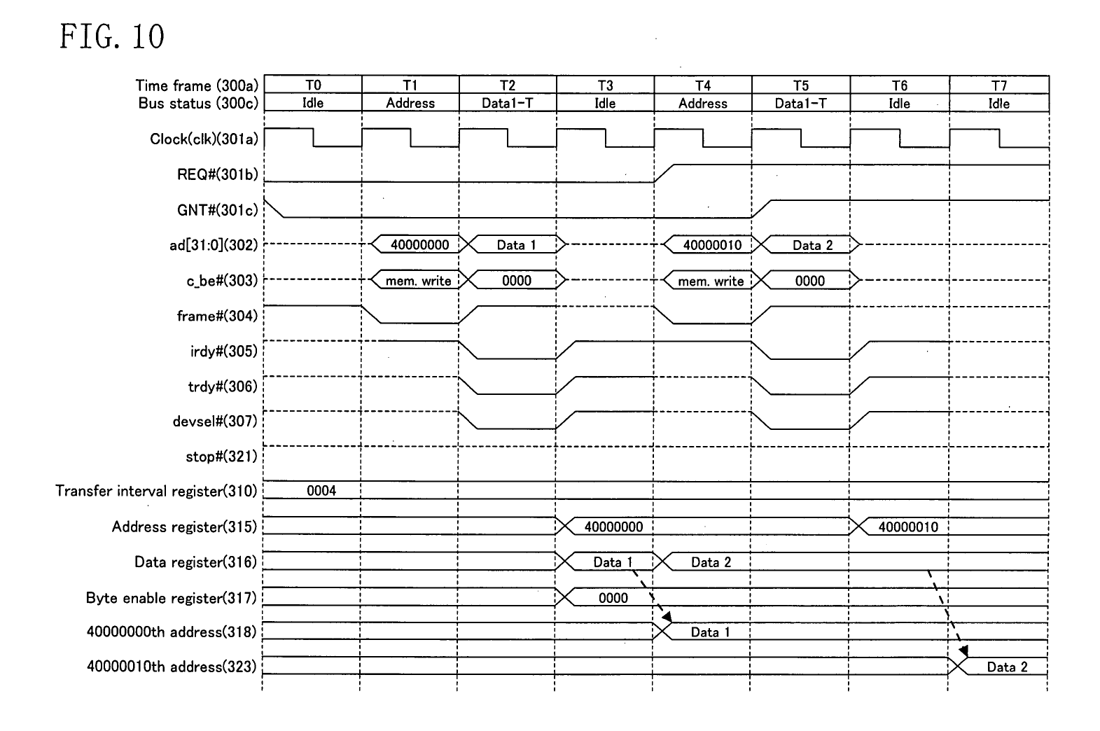

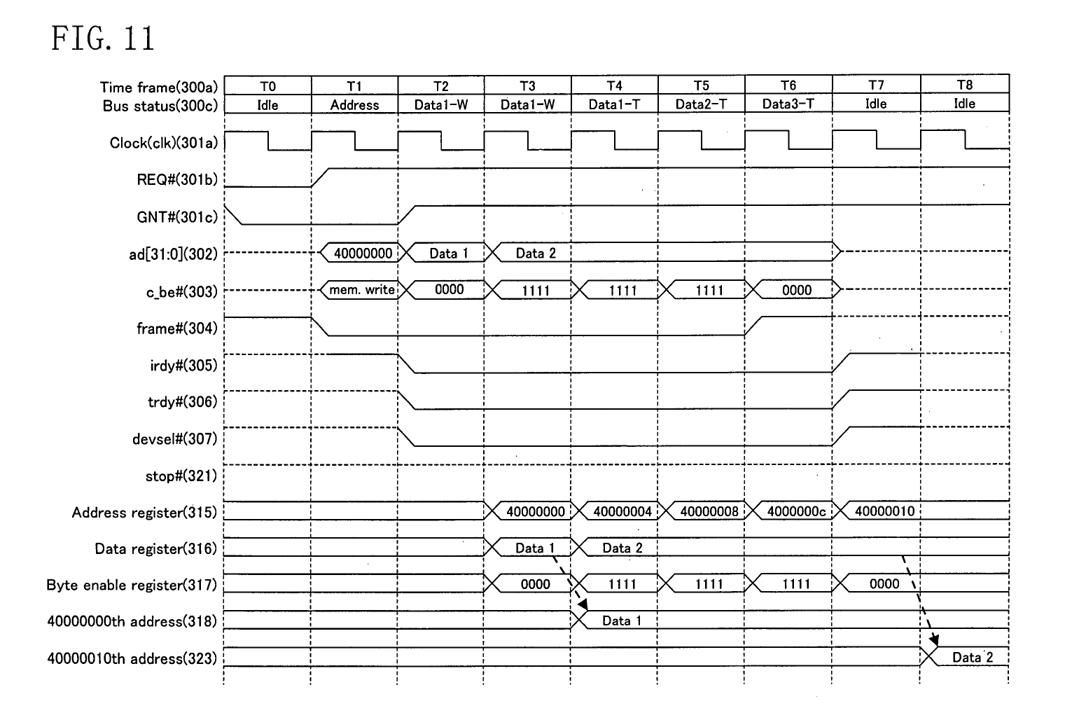

A transfer speed comparison section 119 informs the transfer mode selecting section 120 a value obtained by subtracting the number of clock cycles (B) from the number of clock cycles (A). The number (A) is the number of clock cycles that occur between the time when data transfer in a prior one of two one-word data transfer bus cycles is completed and the time when data transfer in the later one-word data transfer bus cycle is completed; and the number (B) is the number of clock cycles that occur between the time when data transfer with valid data writing in a prior bus cycle is completed and the time when data transfer with valid data writing in a later bus cycle is completed. Herein, the number of clock cycles that occur between the one-word data transfer bus cycles is the sum of one cycle of an idle phase of the PCI bus 180 which occurs after the previous data transfer, one cycle of the address phase, the value of a response delay of the DEVSEL# line 180f, i.e., the value of the DEVSEL# response information register 118, and one cycle of the data phase in which the next data transfer occurs. Thus, the number of clock cycles is equal to the value of the DEVSEL# response information register 118 plus 3. The value of the transfer interval register 113 is subtracted from the value obtained by the above calculation, and the result value is informed to the transfer mode selecting section 120. FIG. 10 is a timing chart that illustrates an exemplary operation of the control system of the control system of embodiment 3. In the example of FIG. 10, time frames T1 and T4 are address phases; the DEVSEL# line 180f is asserted in time frames T2 and T5, which occur immediately after T1 and T4, respectively, as shown in the part 307; and the response of the DEVSEL# line 180f is “FAST”. After data transfer of the first one-word data transfer bus cycle is completed in time frame T2, the bus enters an idle phase in time frame T3. Then, the bus enters an address phase of the second one-word data transfer bus cycle in time frame T4, and the second data transfer is completed in time frame T5. That is, this case includes the following circumstances: the response of the DEVSEL# line 180f is “FAST”; the value of the DEVSEL# response information register 118 is 0; and the number of clock cycles that occur between the time when data transfer in a prior one of two one-word data transfer bus cycles is completed and the time when data transfer in the later one-word data transfer bus cycle is completed is 3. Considering that the value of the transfer interval register 113 is 4 (see part 310 of FIG. 10), the value obtained by the transfer speed comparison section 119 is 3 minus 4, i.e., −1, which is informed to the transfer mode selecting section 120.

In the case where the value informed by the transfer speed comparison section 119 to the transfer mode selecting section 120 is 1 or greater, the transfer speed is faster when a burst transfer scheme is used. Thus, the transfer mode selecting section 120 instructs the burst transfer control section 105a to perform a data transfer. Otherwise, the data transfer speed is faster when one-word data transfer bus cycles continuously occur. Thus, the transfer mode selecting section 120 instructs the one-word data transfer control section 105f to perform a data transfer.

Furthermore, according to embodiment 3, the response of the DEVSEL# line 180f of the PCI target device 140 is “FAST”.

Since the value of the transfer interval register 113 is 4 as shown in the part 310 of FIG. 10, and the response of the DEVSEL# line 180f of the PCI target device 140 is “FAST”, the calculation result of the transfer speed comparison section 119 is −1. Since the calculation result has a value equal to or smaller than 1, the transfer mode selecting section 120 determines that one-word data transfer bus cycle is repeated, and transfer of two pieces of data, Data 1 and Data 2, is completed through the first one-word data transfer bus cycle of time frames T1 and T2 and the second one-word data transfer bus cycle of time frames T4 and T5, respectively.

If the transfer mode employed in this data transfer example is a burst transfer, the final data transfer on the PCI bus 180 is completed in time frame T6, i.e., the data transfer process delays by one cycle.

As described above, according to the PCI master device 101 of embodiment 3, the number of cycles that occur between data transfer operations in a one-word data transfer bus cycle mode is compared with the number of cycles that occur between data transfer operations in a burst transfer according to the value of an interval between data transfer operations and the response speed of the DEVSEL# line 180f. Thus, it is always possible to select the faster transfer mode among the mode of repeating one-word data transfer bus cycle with address jumps and the burst transfer mode.

### Embodiment 4

When a memory connected to a PCI target device has a data write speed slower than the data transfer rate of a PCI bus, a wait is inserted by delaying an acknowledgement during a burst transfer. In embodiment 4, we consider a system wherein the operating speed of the system is determined according to the data write speed of the memory so that the data transfer time of this system during the burst transfer is twice that of the data transfer control system described in embodiment 1. Further, in a PCI target device described herein, a wait cycle is deleted from a data phase in which all of the bits of the C_BE# line are set to 1 to prevent a write operation, whereby the data transfer rate is increased.

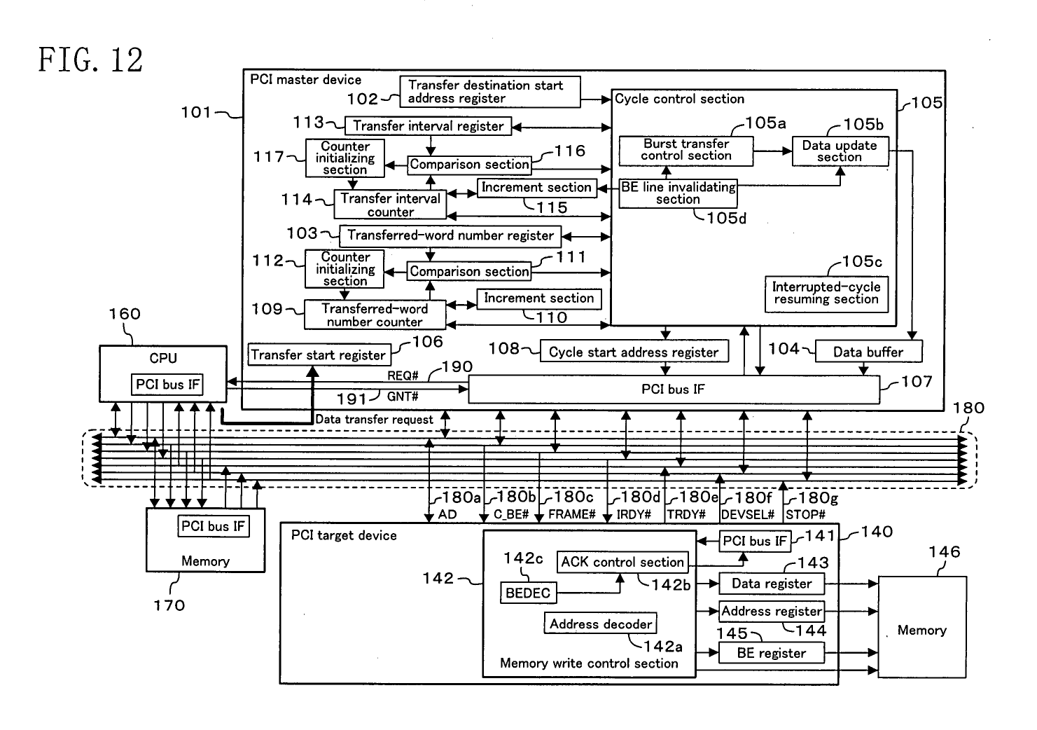

FIG. 12 shows a data transfer control system according to embodiment 4 of the present invention. In FIG. 12, reference numeral 142c denotes a byte enable decoder. Receiving the value of the C_BE# line 180b through the PCI bus interface 141, the byte enable decoder 142c checks whether or not the received value is a value that invalidates a data write, i.e., 1111. If it is 1111, the byte enable decoder 142c instructs the ACK control section 142b to control the PCI bus interface 141 such that the PCI bus interface 141 immediately asserts the TRDY# 180e. Receiving this instruction, the ACK control section 142b instructs the PCI bus interface 141 to immediately assert the TRDY# 180e.

In embodiment 4, we consider that the memory 146 is a slow device, so that the memory 146 requires the time equal to two cycles of a PCI clock for a data write operation, and consider that the PCI bus interface 141 inserts a wait of one clock cycle in each data phase.

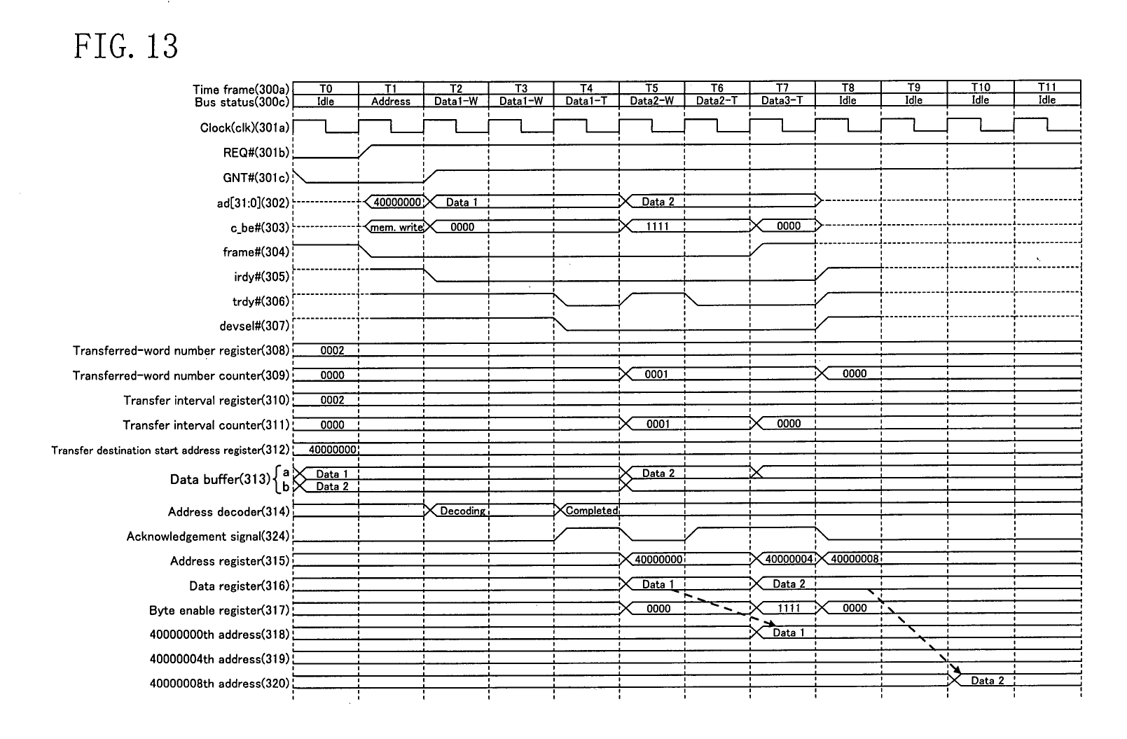

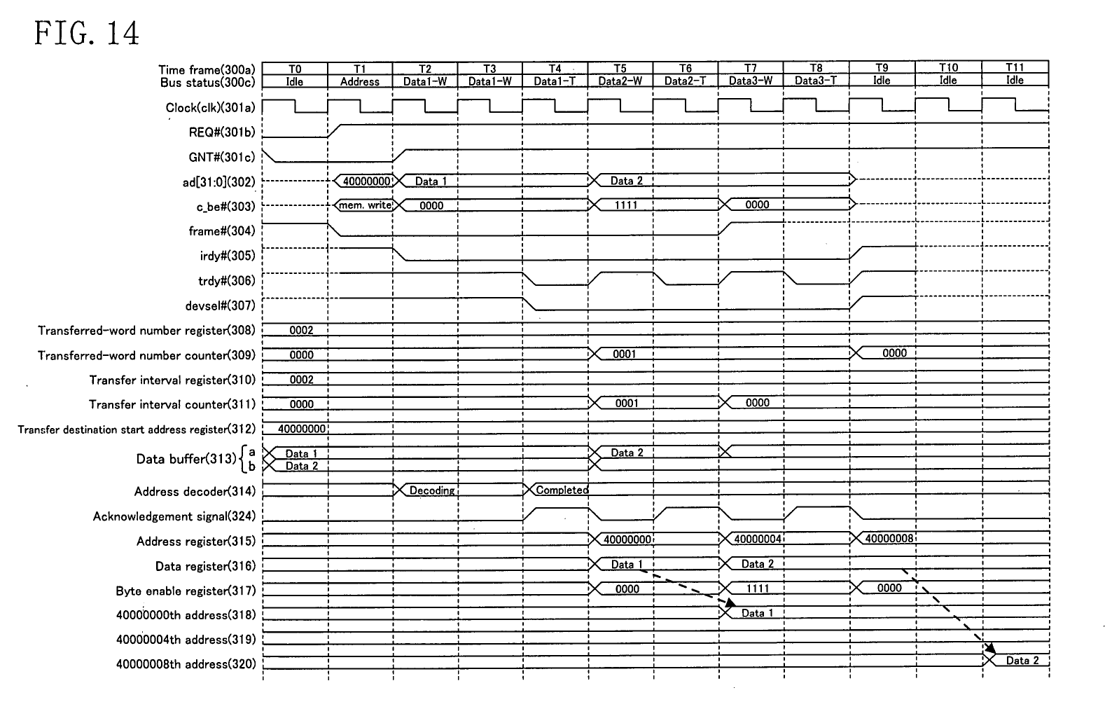

FIG. 13 is a timing chart that illustrates an exemplary operation of the control system of embodiment 4. In FIG. 13, reference numeral 324 denotes an acknowledgement signal from the acknowledgement control section 142b to the PCI bus interface 141. When the acknowledgement signal 324 is asserted to 1, the PCI bus interface 141 immediately asserts the TRDY# 180e to 0 within the same time frame. Since the memory 146 requires two cycles for a data write operation, the acknowledgement signal 324 is asserted with intervals of 1 clock cycle. However, if the byte enable decoder 142c determines that the value of the C_BE# line 180b is 1111, a data write operation in the memory 146 does not occur, and accordingly, the acknowledgement signal 324 is still asserted in time frame T7 continuously from time frame T6 as shown in the part 324 of FIG. 13. As a result, the TRDY# line 180e is continuously asserted over time frames T6 and T7. If the byte enable decoder 142c is not provided in the PCI target device 140, the acknowledgement signal 324 is not asserted in time frame T7 as shown in FIG. 14, and accordingly, the data transfer is delayed.

As described above, in the PCI target device 140 of embodiment 4, a wait is not inserted to the PCI bus 180 at the timing when an actual data write to the memory 146 does not occur, and therefore, the data transfer rate is increased.

### Embodiment 5

In the PCI target device described in embodiment 4, when the PCI target device enters a data phase in which all of the bits of the C_BE# line are 1 such that a data write operation is not performed, the PCI target device does not perform a data write operation into a memory. That is, a next data write operation is kept on standby till the value of the C_BE# line is changed to the valid value. In embodiment 5, the memory 146 is a slow device, as in embodiment 4, so that the memory 146 requires the time equal to two cycles of a PCI clock for a data write operation, and the PCI bus interface 141 inserts a wait of one clock cycle in each data phase. A PCI target device described in embodiment 5 includes, in addition to the functions of the PCI target device of embodiment 4, the function of updating the write address up to a next address in which a data transfer is rendered valid while the all of the bits of the C_BE# line are 1, such that data to be written next, which has been driven onto an AD line, is written in a memory prior to the other data. With this function, the standby time for a memory write operation, which lasts till the value of the C_BE# line is changed to the valid value, is shortened.

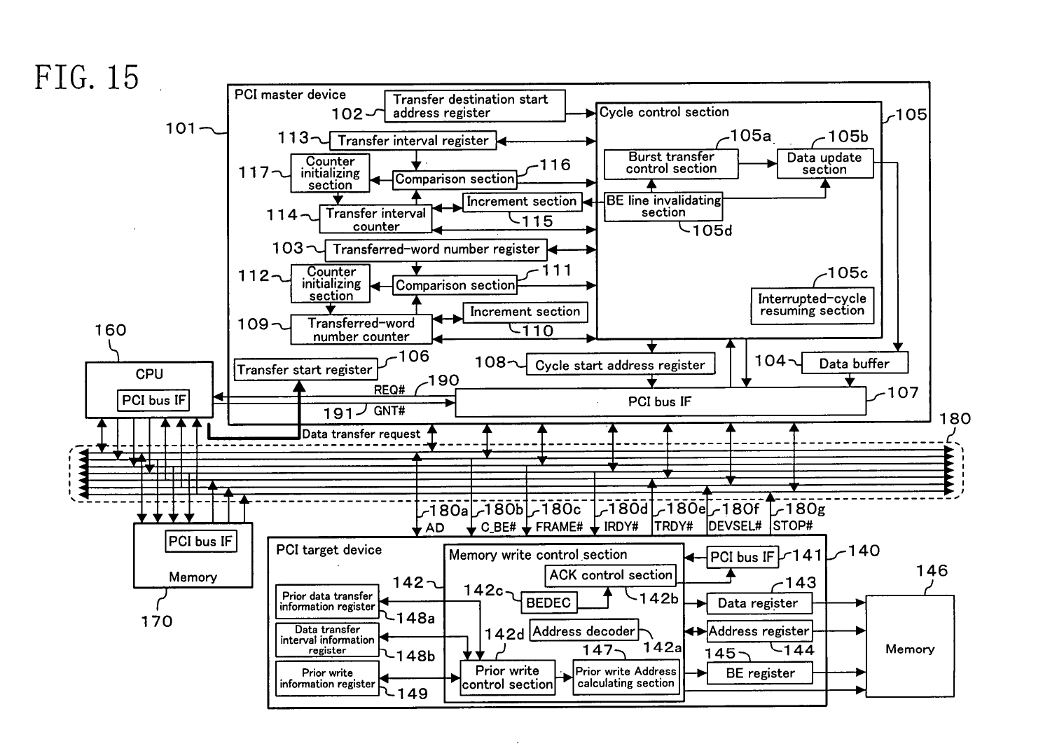

FIG. 15 shows a data transfer control system according to embodiment 5 of the present invention.

When the value of a prior write information register 149 is 0 and the C_BE# line 180b is 1111 in a time frame next to a time frame in which a valid data transfer occurs during the period where the value of a prior data transfer information register 148a is 1, a prior write control section 142d writes a value retained in a prior write address calculating section 147 in the address register 144. Furthermore, the prior write control section 142d instructs the memory write control section 142 to perform a write operation in the memory 146 and writes 1 in the prior write information register 149. When the value of the prior write information register 149 is 1, the prior write control section 142d instructs the memory write control section 142 not to perform a data write operation in the memory 146. When a data transfer is completed while the C_BE# line 180b has the valid value, the memory write control section 142 writes 0 in the prior write information register 149.

When the value of the C_BE# line 180b is 1111 in a time frame next to a time frame where a valid data transfer occurs, the prior write address calculating section 147 calculates an address where a next valid data transfer occurs by adding the value of (the value of a data transfer interval information register 148b)×4 to the value of the address register 144. (The factor of multiplication, “4”, is herein used because the PCI bus 180 has a 32-bit width, i.e., a 4-byte width.)

When the PCI master device 101 drives onto the AD line the next valid data to be transferred in the time frame where the C_BE# line 180b is 1111, the CPU 160 writes 1 in the prior data transfer information register 148a.

The interval between data phases with which the value of the C_BE# line 180b enables a valid data write operation can be set in the data transfer interval information register 148b through the CPU 160.

The value of 1 set in the value of the prior write information register 149 means that a data write operation is performed in an address of the memory 146 to which the value asserted onto the AD line while the value of the C_BE# line 180b is 1111 is transferred next.

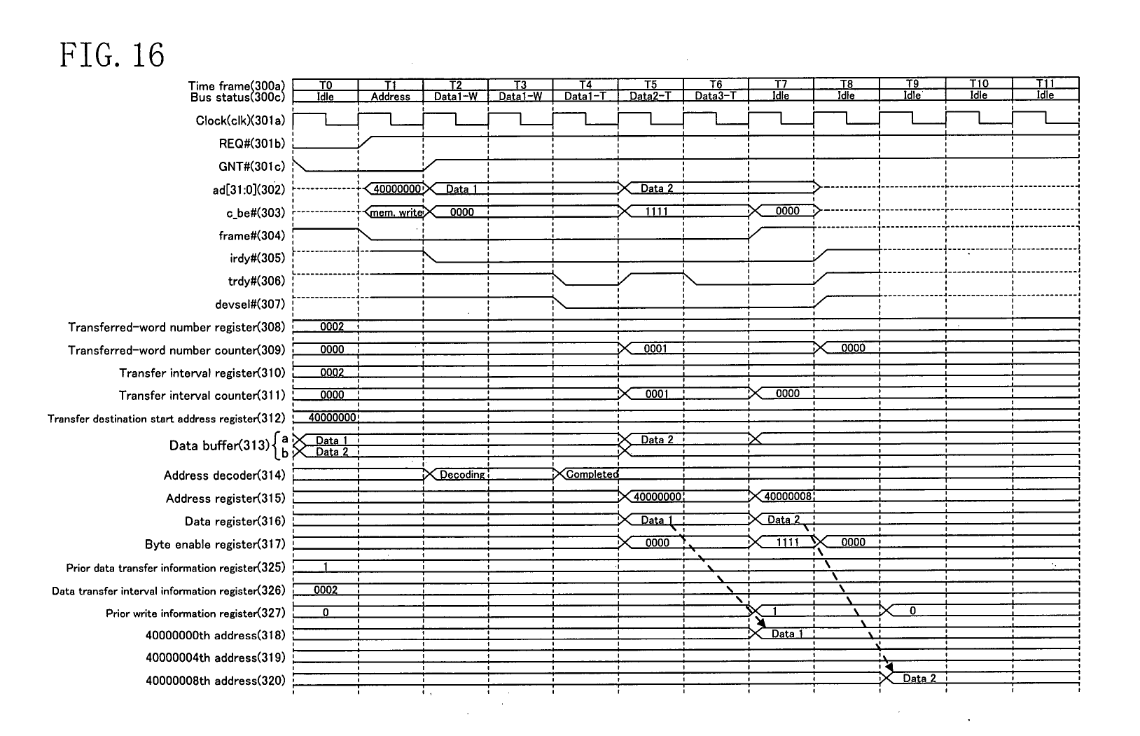

FIG. 16 is a timing chart which illustrates an exemplary operation of the control system of embodiment 5. In FIG. 16, the following reference numerals denote the following particulars:

325: Value of the prior data transfer information register 148a;

326: Value of the data transfer interval information register 148b; and

327: Value of the prior write information register 149.

In embodiment 5, the prior write information register 149 holds 1 as shown in the part 325 of FIG. 16. This indicates that, when the value of the C_BE# line 180b is 1111, the PCI master device 101 drives next valid data to be transferred onto the AD line 180a.

Furthermore, as shown in the part 326, the same value as that of the transfer interval register 113, i.e., 2, is written in the data transfer interval information register 148b.

When the value of “1111” is asserted onto the C_BE# line 180b in time frame T6, the prior write address calculating section 147 determines that an address to which valid data is transferred in time frame T7 is 40000008 by the calculation of adding the value of (the value of a data transfer interval information register 148b)×4, i.e., 8, to the value retained in the address register 144 in the previous time frame (see the part 315 of FIG. 16), i.e., 40000000. The value of 40000008 is written by the prior write control section 142d in the address register 144 as shown in the part 315. The memory write control section 142 starts to write Data 2 in address 40000008 of the memory 146, and the writing is completed in time frame T9. Since 1 is written in the prior write information register 149 in time frame T7 as shown in the part 327, a data write operation in the memory 146 does not occur in time frame T8 where the byte enable register 145 actually have the value of 0000.

If the prior write control section 142d is not provided in the PCI target device 140, writing of the data in address 40000008 is completed in time frame T10 as shown in FIG. 13, and therefore, the device of embodiment 5 completes the data writing operation earlier by one clock cycle.

As described above, in the PCI target device 140 of embodiment 5, actual writing of data in the memory 146 is performed prior to the other operations while the value of the C_BE# line 180b is invalid. Therefore, the data transfer rate is increased.

### Embodiment 6

In the data transfer control system described in embodiment 1, it is possible to perform a burst transfer even when a certain interval exists between destination addresses to which data is to be transferred. In a data transfer control system described in embodiment 6, it is possible to perform a burst transfer even when addresses to which data is not to be transferred exist among a series of destination addresses with certain intervals.

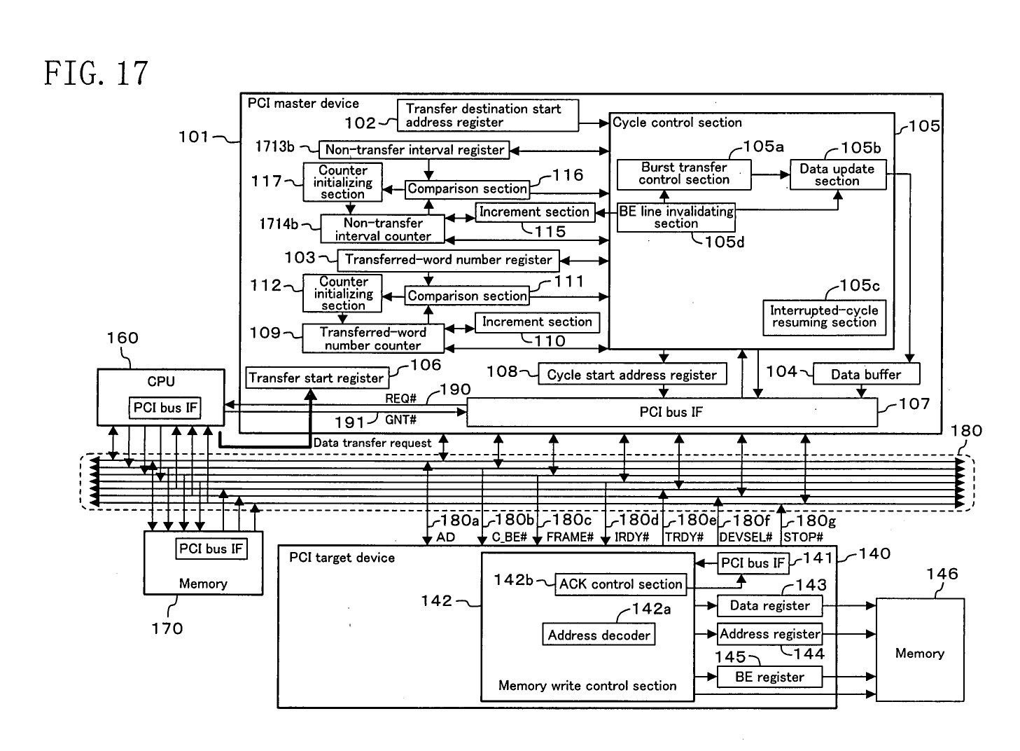

FIG. 17 shows a data transfer control system according to embodiment 6 of the present invention. The differences between the data transfer control system of embodiment 6 and the data transfer control system of embodiment 1 reside in that the cycle control section 105 is replaced by a cycle control section 1705, the transfer interval register 113 is replaced by a non-transfer interval register 1713, and the transfer interval counter 114 is replaced by a non-transfer interval counter 1714.

The operation of the cycle control section 1705 is different from that of the cycle control section 105 of embodiment 1 in the following aspects. If the value of the transfer interval counter 114 is the initial value of 0, the cycle control section 105 sets the C_BE# line 180b to the valid value, whereas if the value of the non-transfer interval counter 1714 is the initial value of 0, the BE# line invalidating section 105d sets the C_BE# line 180b to the invalid value. If the value of the transfer interval counter 114 is not the initial value of 0, the cycle control section 105 sets the C_BE# line 180b to the invalid value through the BE# line invalidating section 105d, whereas if the value of the non-transfer interval counter 1714 is not the initial value of 0, the BE# line invalidating section 105d sets the C_BE# line 180b to the valid value.

The interval between addresses to which data is not to be transferred can be set in the non-transfer interval register 1713 through the CPU 160 by using software.

The value of the non-transfer interval counter 1714 is incremented by the increment section 115 every time a data phase is completed during a burst transfer. When the value of the non-transfer interval counter 1714 reaches the value of the non-transfer interval register 1713, or when a bus cycle is completed, the initial value of 0 is written by the counter initializing section 117 in the non-transfer interval counter 1714. When the value of the non-transfer interval counter 1714 is 0, the C_BE# line 180b is set to the invalid value by the cycle control section 105.

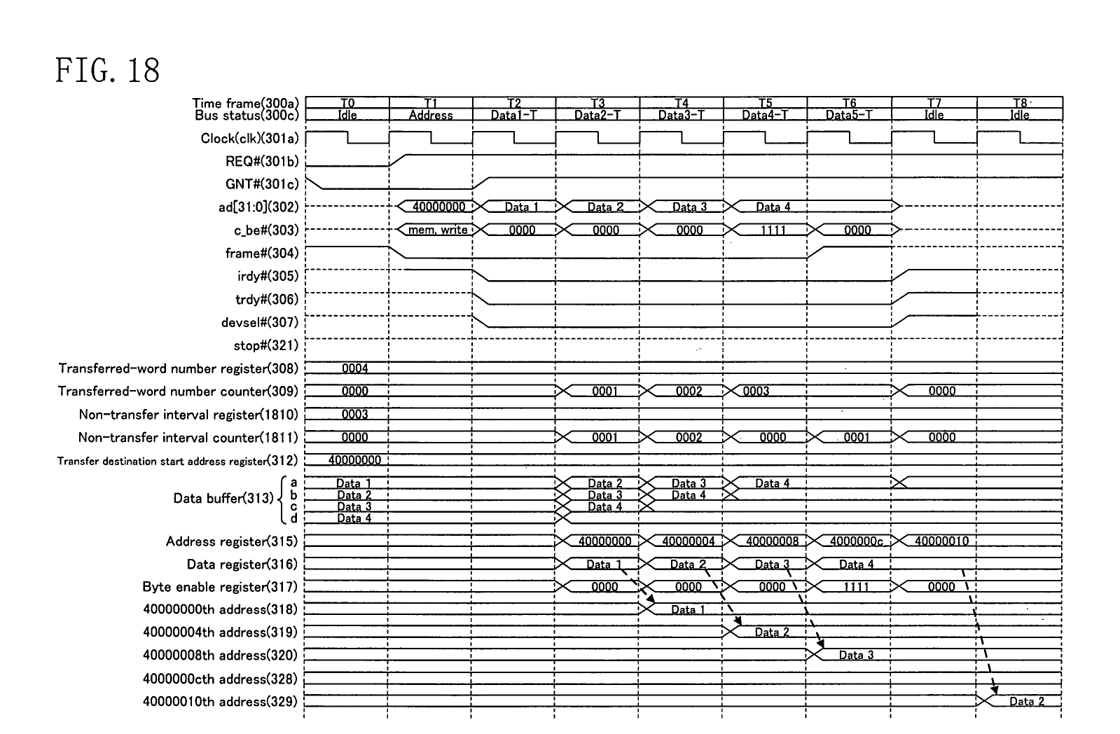

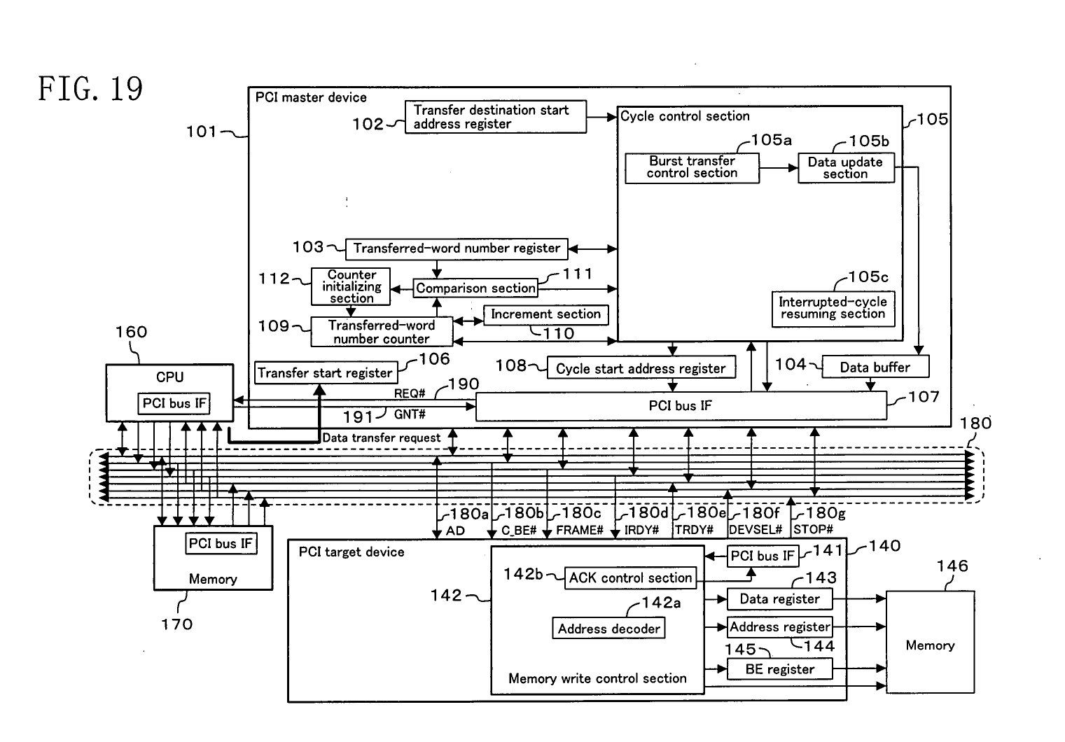

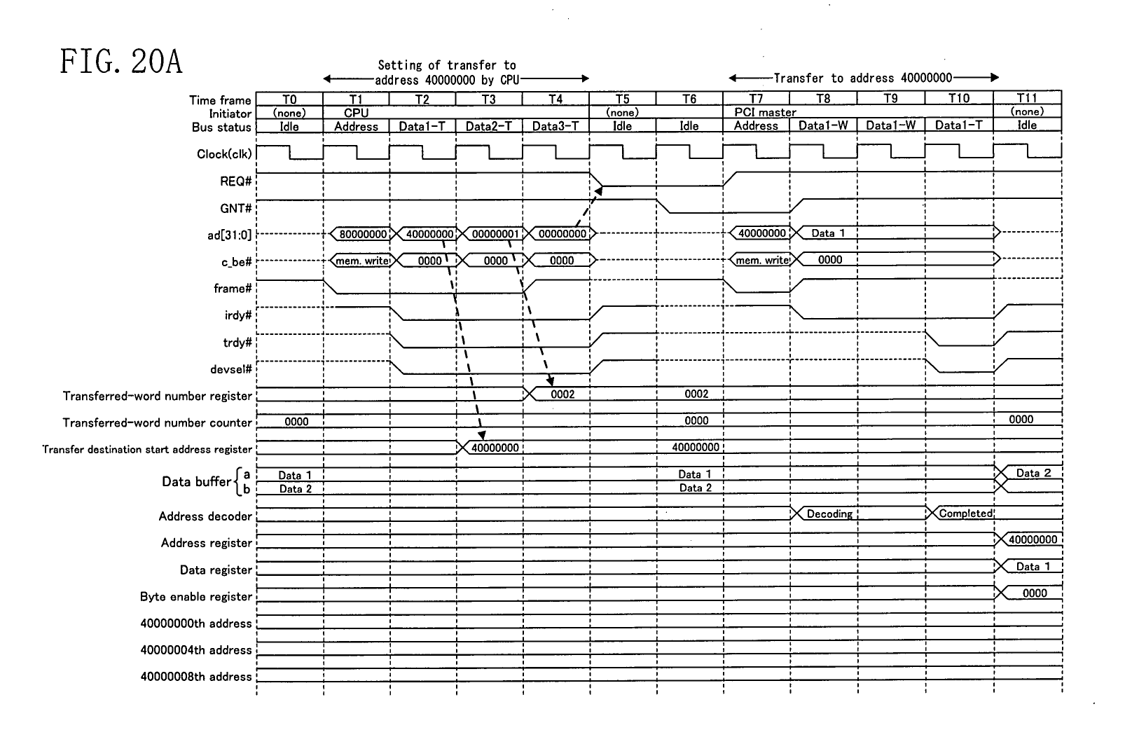

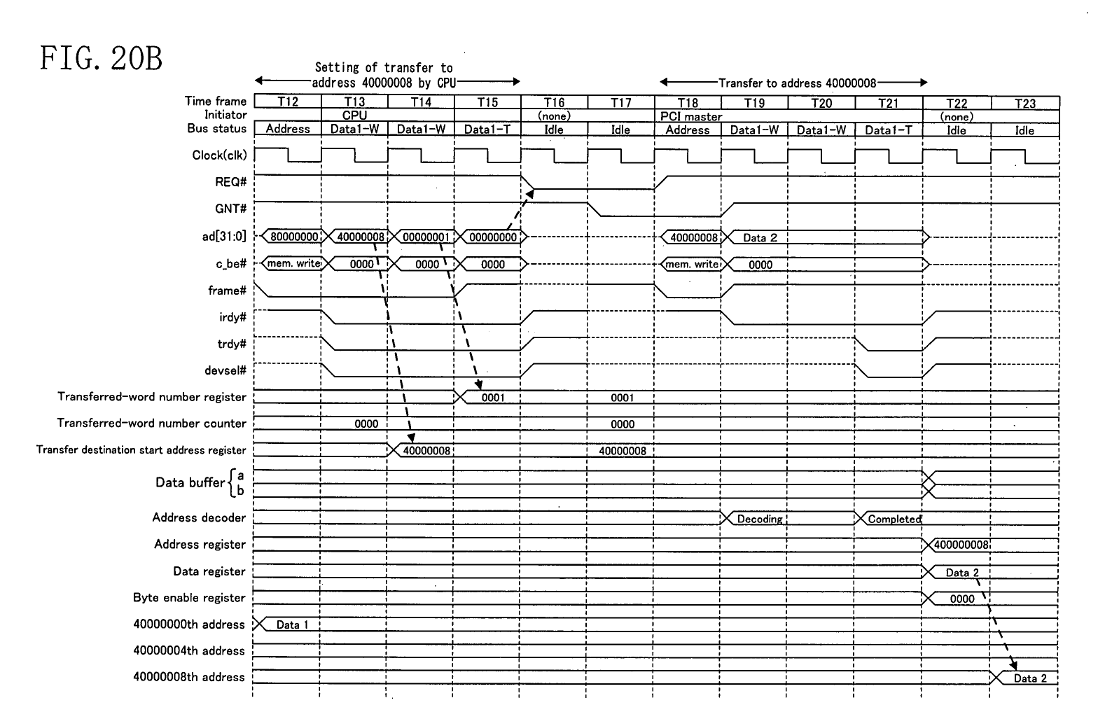

FIG. 18 is a timing chart which illustrates an exemplary operation of the control system of embodiment 6. In FIG. 18, the following reference numerals denote the following particulars:

313: Data of leading four words in the data buffer 104;

313a: Data of the first word in the data buffer 104;

313b: Data of the second word in the data buffer 104;

313c: Data of the third word in the data buffer 104;

313d: Data of the fourth word in the data buffer 104;

1810: Value of the non-transfer interval register 1713; and

1811: Value of the non-transfer interval counter 1714.

In embodiment 6, since 3 is set in the non-transfer interval register 1713, a data phase in which the C_BE# line 180b once has the value of 1111 in time frame T5 occur after the three valid data phases of time frame T2 to time frame T4.

What is claimed is:

1. A data transfer control system connected to a bus for controlling a data transfer to a device on the bus, comprising bus cycle control means for performing a data write operation while maintaining a write control line of the bus in a write-disabled state.

2. A data transfer control system connected to a bus for controlling a data transfer to a device on the bus, comprising:
data storing means for storing data;
transferred-word number storing means for storing the number of words of data which are to be transferred;
transfer interval storing means for storing an interval between destination addresses for one-word data; and
bus cycle controlling means for controlling the data transfer such that, during a burst transfer, a write control line of the bus is placed in a write-enabled state with the interval stored in the transfer interval storing means and is placed in a write-disabled state in the other periods, and that data including a number of words which is equal to the number stored in the transferred-word number storing means is transferred while the write control line is in the write-enabled state.

3. The data transfer control system of claim 2, further comprising:
cycle start address storing means for storing a start address of a bus cycle;
resumption address calculating means for calculating a destination address of second data when being informed by the device about interruption of the data transfer during the time when the data transfer is performed in the write-disabled state; and
interrupted-cycle resuming means for transferring the address calculated by the resumption address calculating means to the cycle start address storing means to start a new bus cycle from the address stored in the cycle start address storing means when being informed by the device about interruption of the data transfer during the time when the data transfer is performed in the write-disabled state.

4. The data transfer control system of claim 2, further comprising:
response speed storing means for storing a device response speed of a target device;
transfer speed comparing means for comparing the data transfer rate in a burst transfer mode with the data transfer rate in a data transfer mode where transfer of one-word data to a destination address is repeated, based on the values of the transfer interval storing means and the response speed storing means; and
transfer mode selecting means for selecting the burst transfer mode if the data transfer rate is faster in the burst transfer mode than in the data transfer mode where transfer of one-word data to a destination address is repeated and, if otherwise, selecting the data transfer mode where one-word data transfer bus cycle for a destination address is repeated.

5. The data transfer control system of claim 3, further comprising:
response speed storing means for storing a device response speed of a target device;
transfer speed comparing means for comparing the data transfer rate in a burst transfer mode with the data transfer rate in a data transfer mode where transfer of one-word data to a destination address is repeated, based on the values of the transfer interval storing means and the response speed storing means; and
transfer mode selecting means for selecting the burst transfer mode if the data transfer rate is faster in the burst transfer mode than in the data transfer mode where transfer of one-word data to a destination address is repeated and, if otherwise, selecting the data transfer mode where one-word data transfer bus cycle for a destination address is repeated.

6. The data transfer control system of claim 2, wherein the bus cycle controlling means drives next one-word data to be transferred onto a data line when the write control line is in the write-disabled state.

7. The data transfer control system of claim 3, wherein the bus cycle controlling means drives next one-word data to be transferred onto a data line when the write control line is in the write-disabled state.

8. The data transfer control system of claim 4, wherein the bus cycle controlling means drives next one-word data to be transferred onto a data line when the write control line is in the write-disabled state.

9. A data transfer control system, comprising bus response means for informing, when a data write operation is performed while a write control line of a bus is in a write-disabled state, reception of data earlier than in the case where the write control line is in a write-enabled state.

10. A data transfer control system, comprising:
storing means for storing an interval between destination addresses of data; and
controlling means for obtaining, when a data write operation is performed while a write control line of a bus is in a write-disabled state, a next address where the write control line is turned into a write-enabled state based on a value stored in the storing means to write a value of a signal driven onto a data line in the obtained address.

11. A data transfer control system connected to a bus for controlling a data transfer to a device on the bus, comprising:
data storing means for storing data;
transferred-word number storing means for storing the number of words of data which are to be transferred;
non-transfer interval storing means for storing an interval between addresses to which the data is not to be transferred;
bus cycle controlling means for controlling the data transfer such that, during a burst transfer, a write control line of the bus is placed in a write-disabled state with the interval stored in the non-transfer interval storing means and is placed in a write-enabled state in the other periods, and that data including a number of words which is equal to the number stored in the transferred-word number storing means is transferred while the write control line is in the write-enabled state.

12. A data transfer control method for controlling a data transfer to a device on a bus, comprising:
a data storing step of storing data;
a transferred-word number storing step of storing the number of words of data which are to be transferred;
a transfer interval storing step of storing an interval between data destination addresses; and
a bus cycle controlling step of controlling the data transfer such that, during a burst transfer, a write control line of the bus is placed in a write-enabled state with the interval stored at the transfer interval storing step and is placed in a write-disabled state in the other periods, and that data including a number of words which is equal to the number stored at the transferred-word number storing step is transferred while the write control line is in the write-enabled state.
